(19) United States
(12) Patent Application Publication
(10) Pub. No.: US 2021/0347061 A1
(43) Pub. Date: Nov. 11, 2021

(54) INFORMATION PROCESSING APPARATUS, INFORMATION PROCESSING SYSTEM, INFORMATION PROCESSING METHOD, AND PROGRAM

(71) Applicant: SONY CORPORATION, Tokyo (JP)

(72) Inventors: Noriko TOTSUKA, Tokyo (JP); Hirotaka SUZUKI, Kanagawa (JP); Hiroaki OGAWA, Chiba (JP); Tobias CINCAREK, Tokyo (JP); Kazuki OCHIAI, Kanagawa (JP); Kanako WATANABE, Tokyo (JP); Shohei YAMAMOTO, Kanagawa (JP)

(73) Assignee: SONY CORPORATION, Tokyo (JP)

(21) Appl. No.: 17/281,057

(22) PCT Filed: Sep. 26, 2019
(86) PCT No.: PCT/JP2019/037879

§ 371 Date: Mar. 29, 2021

(30) Foreign Application Priority Data
Oct. 10, 2018 (JP) 2018-191510

(51) Int. Cl. B25J 11/00; A47J 44/00; A47J 27/00; A47J 36/32; B25J 9/16

(52) U.S. Cl. CPC B25J 11/0045; A47J 44/00; B25J 9/163; A47J 36/321; B25J 9/1602; A47J 27/004

(57) ABSTRACT

There is achieved a configuration in which suspension of cooking being performed by a cooking robot is controlled to enable cooking to be completed at the expected time for a user to return home. Included are an expected return home time estimation unit that estimates an expected time to return home at which the user is expected to return home; an expected cooking completion time estimation unit that estimates an expected time to complete cooking at which a cooking robot is expected to complete cooking; and a cooking execution control unit that controls the cooking robot. In a case where a difference (X−Y) between the expected time to return home (X) estimated by the expected return home time estimation unit and the expected time to complete cooking (Y) estimated by the expected cooking completion time estimation unit is not less than a predetermined threshold value (Th), the cooking execution control unit performs control to cause the cooking robot to suspend cooking so that cooking can be completed at the expected time to return home (X).

### TECHNICAL FIELD

The present disclosure relates to an information processing apparatus, an information processing system, an information processing method, and a program. More specifically, the present disclosure relates to an information processing apparatus, an information processing system, an information processing method, and a program for controlling the timing at which cooking is completed by a cooking robot.

### BACKGROUND ART

Cooking robots have been developed which cook by following various recipes, and it is expected that the cooking robots will be widely used not only in restaurants but also in households in the future.

One of functions required of such a cooking robot is to “complete cooking in time for a user's return home”. For example, this corresponds to the following function of the cooking robot: cooking a dish at home while the user is out, and providing the freshly cooked dish at the timing when the user returns home.

Required cooking time can be grasped according to what is cooked, that is, a recipe. Thus, it is possible to adjust cooking finish time by controlling cooking start timing on the basis of the required cooking time.

However, the time when the user will return home may fall behind schedule due to, for example, delay of a train. In such a case, if cooking is completed at the cooking finish time that has been initially set, the dish is ready earlier than the time when the user returns home. Therefore, the user will not be able to eat the freshly cooked dish, and will be provided with cold dish.

Note that Patent Document 1 (Japanese Patent Application Laid-Open No. 2017-27418) is a prior art document that discloses a technique for providing the most suitable recipe information on the basis of desired cooking completion time.

Furthermore, Patent Document 2 (Japanese Patent Application Laid-Open No. 2017-4250) discloses a cooking support system that teaches a cooking process to a user, the system presenting a cooking process in which cooking can be suspended at the convenience of the user.

However, both of the above are directed for cooking to be performed by a user, that is, a person, and neither of the above discloses a configuration for controlling a robot that performs cooking.

### CITATION LIST

### Patent Document

Patent Document 1: Japanese Patent Application Laid-Open No. 2017-27418
Patent Document 2: Japanese Patent Application Laid-Open No. 2017-4250

### SUMMARY OF THE INVENTION

### Problems to be Solved by the Invention

The present disclosure implements a configuration for controlling the timing at which cooking is completed by a cooking robot, and an object of the present disclosure is to provide an information processing apparatus, an information processing system, an information processing method, and a program capable of providing a user with a freshly cooked dish by, for example, controlling cooking completion time according to the user's convenience to complete cooking at the time desired by the user.

### Solutions to Problems

A first aspect of the present disclosure is an information processing apparatus including:
an expected return home time estimation unit that estimates an expected time to return home at which a user is expected to return home;
an expected cooking completion time estimation unit that estimates an expected time to complete cooking at which a cooking robot is expected to complete cooking; and
a cooking execution control unit that controls the cooking robot,
in which the cooking execution control unit controls the cooking robot according to the expected time to return home (X) estimated by the expected return home time estimation unit and the expected time to complete cooking (Y) estimated by the expected cooking completion time estimation unit.

In addition, a second aspect of the present disclosure is an information processing system including:
a user terminal; and
a cooking robot control apparatus that controls a cooking robot,
in which the user terminal transmits location information to the cooking robot control apparatus,
the cooking robot control apparatus includes:
an expected return home time estimation unit that estimates an expected time to return home at which a user is expected to return home, on the basis of the location information received from the user terminal;
an expected cooking completion time estimation unit that estimates an expected time to complete cooking at which the cooking robot is expected to complete cooking; and
a cooking execution control unit that controls the cooking robot, and
the cooking execution control unit controls the cooking robot according to the expected time to return home (X) estimated by the expected return home time estimation unit and the expected time to complete cooking (Y) estimated by the expected cooking completion time estimation unit.

Furthermore, a third aspect of the present disclosure is an information processing method to be performed in an information processing apparatus, the method including:
an expected return home time estimation step of causing an expected return home time estimation unit to estimate an expected time to return home (X) at which a user is expected to return home;
an expected cooking completion time estimation step of causing an expected cooking completion time estimation unit to estimate an expected time to complete cooking (Y) at which a cooking robot is expected to complete cooking; and
a cooking execution control step of causing a cooking execution control unit to control the cooking robot,
in which the cooking execution control step includes controlling the cooking robot according to the expected time to return home (X) and the expected time to complete cooking (Y).

Moreover, a fourth aspect of the present disclosure is an information processing method to be performed in an information processing system including a user terminal and a cooking robot control apparatus that controls a cooking robot, the method including:
causing the user terminal to transmit location information to the cooking robot control apparatus; and
causing the cooking robot control apparatus to perform:
an expected return home time estimation process of estimating an expected time to return home (X) at which a user is expected to return home, on the basis of the location information received from the user terminal;
an expected cooking completion time estimation process of estimating an expected time to complete cooking at which the cooking robot is expected to complete cooking; and
a cooking execution control process of controlling the cooking robot,
in which the cooking execution control process includes controlling the cooking robot according to the expected time to return home (X) and the expected time to complete cooking (Y).

In addition, a fifth aspect of the present disclosure is a program for causing an information processing apparatus to perform information processing, the program causing the information processing apparatus to perform:
an expected return home time estimation step of causing an expected return home time estimation unit to estimate an expected time to return home (X) at which a user is expected to return home;
an expected cooking completion time estimation step of causing an expected cooking completion time estimation unit to estimate an expected time to complete cooking (Y) at which a cooking robot is expected to complete cooking; and
a cooking execution control step of causing a cooking execution control unit to control the cooking robot,
in which the cooking execution control step includes controlling the cooking robot according to the expected time to return home (X) and the expected time to complete cooking (Y).

Note that the program according to the present disclosure is, for example, a program that can be provided through a storage medium or a communication medium to be provided in a computer-readable form to an information processing apparatus or a computer system that can execute various program codes. As a result of providing such a program in a computer-readable form, a process corresponding to the program is implemented on the information processing apparatus or the computer system.

Still other objects, features, and advantages of the present disclosure will be apparent from more detailed descriptions based on embodiments of the present disclosure to be described later and the accompanying drawings. Note that in the present specification, the term “system” refers to a logical set configuration of a plurality of devices, and is not limited to one in which the devices of each configuration are in the same casing.

### Effects of the Invention

The configuration of one embodiment of the present disclosure achieves a configuration in which suspension of cooking being performed by the cooking robot is controlled to enable cooking to be completed at the expected time for the user to return home.

Specifically, included are, for example, an expected return home time estimation unit that estimates an expected time to return home at which a user is expected to return home; an expected cooking completion time estimation unit that estimates an expected time to complete cooking at which a cooking robot is expected to complete cooking; and a cooking execution control unit that controls the cooking robot. In a case where a difference (X−Y) between the expected time to return home (X) estimated by the expected return home time estimation unit and the expected time to complete cooking (Y) estimated by the expected cooking completion time estimation unit is not less than a predetermined threshold value (Th), the cooking execution control unit performs control to cause the cooking robot to suspend cooking so that cooking can be completed at the expected time to return home (X).

The present configuration achieves a configuration in which suspension of cooking being performed by the cooking robot is controlled to enable cooking to be completed at the expected time for the user to return home.

Note that the effects described in the present specification are merely illustrative and not restrictive, and additional effects may also be achieved.

### BRIEF DESCRIPTION OF DRAWINGS

FIG. 1 is a sequence diagram illustrating an example of a process sequence for processing to be performed by a cooking robot control apparatus of the present disclosure.

FIG. 2 is a sequence diagram illustrating the example of the process sequence for processing to be performed by the cooking robot control apparatus of the present disclosure.

FIG. 3 is a sequence diagram illustrating the example of the process sequence for processing to be performed by the cooking robot control apparatus of the present disclosure.

FIG. 4 is a diagram illustrating an example of processing to be performed by the cooking robot control apparatus of the present disclosure.

FIG. 5 is a diagram illustrating an example of processing to be performed by the cooking robot control apparatus of the present disclosure.

FIG. 6 is a diagram illustrating a configuration example of the cooking robot control apparatus of the present disclosure.

FIG. 7 shows a flowchart describing a process sequence for processing to be performed by the cooking robot control apparatus of the present disclosure.

FIG. 8 shows a flowchart describing the process sequence for the processing to be performed by the cooking robot control apparatus of the present disclosure.

FIG. 9 shows a flowchart describing the process sequence for the processing to be performed by the cooking robot control apparatus of the present disclosure.

FIG. 10 shows a flowchart describing the process sequence for the processing to be performed by the cooking robot control apparatus of the present disclosure.

FIG. 11 shows a flowchart describing the process sequence for the processing to be performed by the cooking robot control apparatus of the present disclosure.

FIG. 12 shows a flowchart describing the process sequence for the processing to be performed by the cooking robot control apparatus of the present disclosure.

FIG. 13 shows a flowchart describing the process sequence for the processing to be performed by the cooking robot control apparatus of the present disclosure.

FIG. 14 is a diagram illustrating an example of a break point determination process to be performed by the cooking robot control apparatus of the present disclosure.

FIG. 15 shows a flowchart describing a process sequence for a cooking process determination and break point determination process to be performed by the cooking robot control apparatus of the present disclosure.

FIG. 16 is a diagram illustrating a hardware configuration example of an information processing apparatus corresponding to the cooking robot control apparatus of the present disclosure.

### MODE FOR CARRYING OUT THE INVENTION

Details of an information processing apparatus, an information processing system, an information processing method, and a program according to the present disclosure will be described below with reference to the drawings. Note that description will be provided in accordance with the following items.

1. Regarding Outline of Processing to Be Performed by Information Processing Apparatus (Cooking Robot Control Apparatus)

2. Regarding Configuration Example of Cooking Robot Control Apparatus

3. Regarding Sequence for Processing to Be Performed by Cooking Robot Control Apparatus of Present Disclosure

4. Regarding Process for Determining Cooking Process and Cooking Break Point

5. Regarding Other Embodiments

6. Regarding Hardware Configuration Example of Information Processing Apparatus

7. Summary of Configurations of Present Disclosure

[1. Regarding Outline of Processing to be Performed by Information Processing Apparatus (Cooking Robot Control Apparatus)]

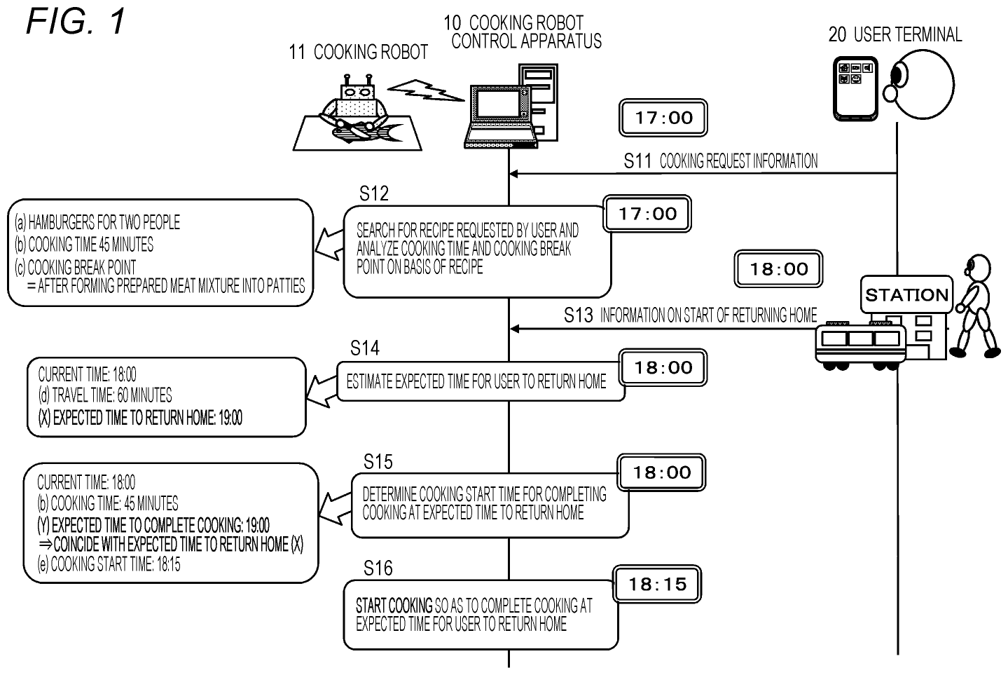

First, the outline of processing to be performed by an information processing apparatus (cooking robot control apparatus) of the present disclosure will be described with reference to FIG. 1 and subsequent drawings.

The information processing apparatus of the present disclosure is an apparatus that controls the timing at which cooking is completed by a cooking robot that performs cooking.

Note that the information processing apparatus of the present disclosure may be configured such that the information processing apparatus is integrated with the cooking robot, or may be configured separately from the cooking robot. The information processing apparatus of the present disclosure adjusts the timing of completion of cooking by controlling an execution sequence for cooking to be performed by the cooking robot.

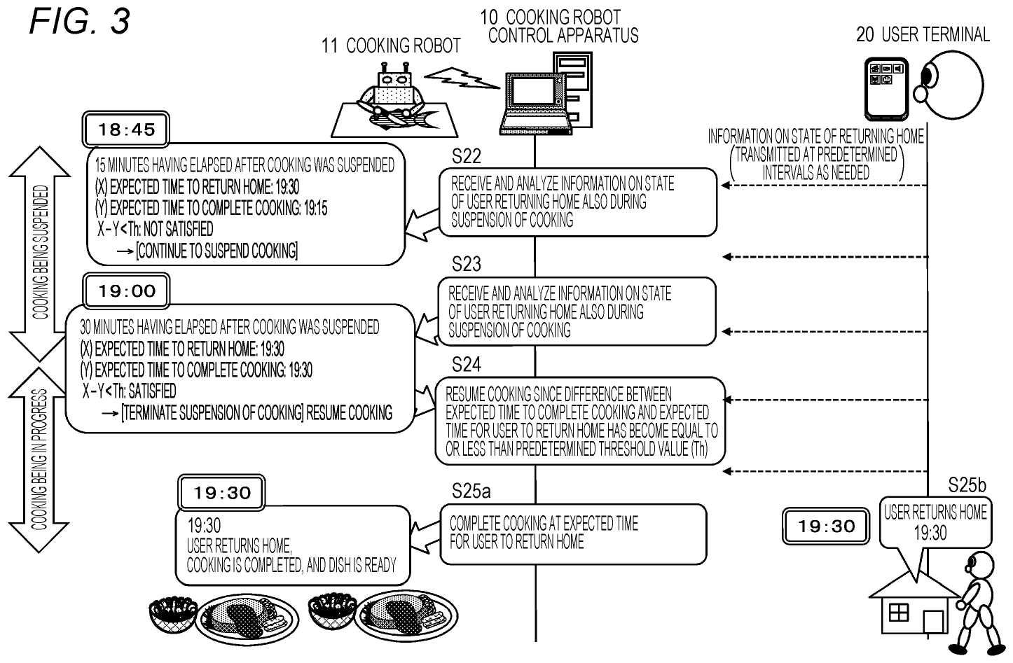

First, the outline of processing to be performed by the information processing apparatus of the present disclosure will be described with reference to the sequence diagrams shown in FIGS. 1 to 3.

FIGS. 1 to 3 show a cooking robot control apparatus 10 and a cooking robot 11 on the left side, and a user terminal 20 on the right side.

The cooking robot control apparatus 10 shown on the left side or a combination of the cooking robot control apparatus 10 and the cooking robot 11 corresponds to the information processing apparatus of the present disclosure.

The cooking robot control apparatus 10 controls the cooking robot 11. Specifically, the cooking robot control apparatus 10 causes the cooking robot 11 to perform cooking according to various recipes, and also outputs commands to, for example, start, end, and suspend cooking to the cooking robot 11 so as to control execution of the cooking process.

Moreover, the cooking robot control apparatus 10 performs communication with the user terminal 20 held by a user, so that the cooking robot control apparatus 10 performs a process of analyzing information received from the user terminal, and controls the cooking robot 11 according to the result of the analysis.

The user terminal 20 is a communicable terminal such as a smartphone (smartphone), a tablet terminal, or a PC.

The sequence diagrams shown in FIGS. 1 to 3 show an example of a process sequence for processing to be performed between the cooking robot control apparatus 10 and the cooking robot 11 shown on the left side and the user terminal 20 shown on the right side. Step S11 and the subsequent steps are performed in sequence.

The user holding the user terminal 20 is out, and the cooking robot 11 and the cooking robot control apparatus 10 are in the user's house.

The cooking robot control apparatus 10 receives a request from the user terminal 20, and causes the cooking robot 11 to perform cooking and complete cooking at the timing when the user returns home.

Note that the cooking robot control apparatus 10 can acquire accurate current time information on the basis of an internal clock function or time information provided by a time information providing server, and performs various types of processing according to the acquired time information. The sequence diagrams shown in FIGS. 1 to 3 show time information for processing and the like to be performed by the cooking robot control apparatus 10 and the like.

Hereinafter, processing in each step will be described in sequence.

(Step S11) [Time=17:00]

First, in step S11, the user who is out of the house uses the user terminal 20 such as a smartphone to transmit a cooking request to the cooking robot control apparatus 10 located at home. The request is transmitted at 17:00.

For example, transmitted is a request such as “Cook two hamburgers such that the hamburgers are ready at the time of returning home”.

Note that the user can make a cooking request by using the user terminal 20 such as a smartphone while being out as described above, but in addition, it is also possible for the user to, for example, input cooking request information to the cooking robot control apparatus 10 at home before going out.

Note that the user terminal 20 continuously or intermittently transmits, to the cooking robot control apparatus 10, location information acquired by a position identification application such as the GPS provided in the user terminal 20.

After the cooking robot control apparatus 10 receives the request from the user terminal 20, or after the user notifies the cooking robot control apparatus 10 of the start of returning home by using the user terminal 20, the cooking robot control apparatus 10 continuously or intermittently receives location information from the user terminal 20 to check the location of the user as needed until the user returns home.

Moreover, the cooking robot control apparatus 10 receives operation information or the like on a transportation system to be used by the user, such as a train, from an external server such as a traffic information providing server, and acquires information on a delay of a train or the like, information on traffic congestion, and the like.

The cooking robot control apparatus 10 estimates the time when the user will return home on the basis of these pieces of information, and also sequentially updates the estimated time according to the situation.

(Step S12) [Time=17:00]

When receiving the request from the user terminal 20, the cooking robot control apparatus 10 searches for a recipe requested by the user, and estimates cooking time and a cooking break point from the recipe, in step S12.

The recipe is acquired from an external server such as a recipe information providing server that can be accessed via a communication network such as the Internet, or from a storage unit of the cooking robot control apparatus 10 or the cooking robot 11.

The cooking robot control apparatus 10 analyzes the cooking time and the cooking break point for the recipe requested by the user on the basis of the recipe.

As a result of this analysis process, the following data are stored in a memory (storage unit) of the cooking robot control apparatus 10 as shown in, for example, FIG. 1.

(a) Dish to be cooked=hamburgers for two people

(b) Cooking time=45 minutes

(c) Cooking break point=after forming prepared meat mixture into patties

Note that a specific example of a cooking break point setting process will be described later.

(Step S13) [Time=18:00]

In step S13, the user holding the user terminal 20 arrives at a train station for returning home. At this time, the user may use the user terminal 20 to notify the cooking robot control apparatus 10 of the start of returning home. The location information on the user having arrived at the station is transmitted from the user terminal 20 to the cooking robot control apparatus 10.

(Step S14) [Time=18:00]

When detecting that the user has arrived at the station on the basis of the user location information received from the user terminal 20, the cooking robot control apparatus 10 estimates the time when the user will return home, in step S14.

The cooking robot control apparatus 10 acquires operation information on the train to be used by the user from the external traffic information providing server, and estimates the time when the user will return home on the basis of the user's current location, the train operation information, and the like.

Note that the cooking robot control apparatus 10 also holds location information on the user's home in the storage unit, and estimates the time when the user will return home in consideration of the user's travel time on the train and time required to walk from the nearest station to the user's home.

As a result of this estimation process, the cooking robot control apparatus 10 generates, for example, the following data and stores the data in the memory (storage unit) of the cooking robot control apparatus 10.

(d) Travel time=60 minutes

(X) Expected time to return home=19:00

(Step S15) [Time=18:00]

Moreover, in step S15, the cooking robot control apparatus 10 calculates and determines cooking start time such that the cooking of the dish (hamburgers for two people) requested by the user is completed at the expected time for the user to return home (19:00). As a result of this calculation process, the cooking robot control apparatus 10 generates, for example, the following data, and stores the data in the memory (storage unit) of the cooking robot control apparatus 10.

(Y) Expected time to complete cooking=19:00 (=(X) expected time to return home)

(e) Cooking start time=18:15

That is, the cooking robot control apparatus 10 sets (Y) expected time to complete cooking to 19:00 so that (Y) expected time to complete cooking coincides with (X) expected time to return home=19:00.

In addition, the cooking robot control apparatus 10 calculates and records in the memory, the following cooking start time for completing, at 19:00, the cooking that takes the following cooking time that has been previously calculated on the basis of the recipe:

(e) cooking start time=18:15, and

(b) cooking time=45 minutes.

(Step S16) [Time=18:15]

Next, in step S16, when the “cooking start time=18:15” recorded in the memory is reached, the cooking robot control apparatus 10 starts cooking such that cooking of the dish (hamburgers for two people) requested by the user is completed at the expected time for the user to return home (19:00).

(Steps S17 and S18) [Time=18:15 and thereafter]

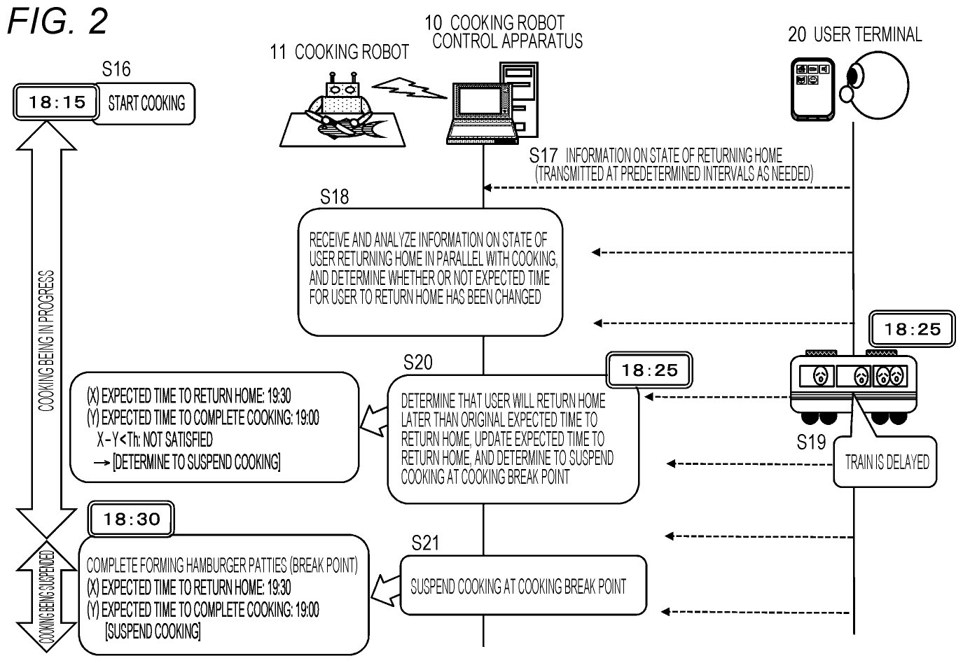

As shown in FIG. 2, even after the start of cooking, the cooking robot control apparatus 10 continuously or intermittently receives the location information from the user terminal 20, and checks the user's location as needed. Moreover, the cooking robot control apparatus 10 also receives operation information or the like on the transportation system to be used by the user, such as the train, from an external server such as the traffic information providing server, and acquires information on a delay of the train or the like, information on traffic congestion, and the like.

The cooking robot control apparatus 10 determines whether or not the expected time for the user to return home has been changed, on the basis of these pieces of information.

(Step S19) [Time=18:25]

In step S19, the train taken by the user is delayed.

(Step S20) [Time=18:25]

The cooking robot control apparatus 10 determines that the user will return home later than the original expected time to return home, on the basis of the location information received from the user terminal 20 and delay information on the train or the like received from an external server such as the traffic information providing server, and performs an update process for changing the following data calculated and stored in the memory in step S14 above:

(X) expected time to return home=19:00. That is, the data are updated as follows and recorded in the memory.

(X) Expected time to return home=19:30

Moreover, regarding the following data Y calculated and stored in the memory in step S15 above, the cooking robot control apparatus 10 compares the data Y (expected time to complete cooking) with the above data X (expected time to return home):

(Y) expected time to complete cooking: 19:00. Specifically, as shown below, it is determined whether or not a difference (time difference) between X (expected time to return home) and the data Y (expected time to complete cooking) is less than a predetermined threshold value (Th). For example, the cooking robot control apparatus 10 performs a determination process according to the following (determination formula).

X−Y<Th (determination formula)

In a case where the above (determination formula) is not satisfied, that is, in a case where the difference (time difference: X−Y) between X (expected time to return home) and the data Y (expected time to complete cooking) is not less than the predetermined threshold value (Th), the cooking robot control apparatus 10 determines to perform a cooking suspension process.

Note that here, as an example, the threshold value (Th) is set such that the threshold value (Th)=1 (min).

Note that the above determination formula is an example. The determination formula can be set in various ways, and can be freely set by the user. For example, the determination formula can be set in various ways as described above, and can be freely set by the user as follows:

the threshold value (Th)=5 (min), or

the threshold value (Th)=10 (min).

The case where the threshold value (Th) is set as follows will be described below as an example: the threshold value (Th)=1 (min).

When X−Y=(19:30)−(19:00)=30,

X−Y=30<1(Th) (determination formula).

Thus, the above (determination formula) is not satisfied. That is, the difference (time difference: X−Y) between X (expected time to return home) and the data Y (expected time to complete cooking) is not less than the predetermined threshold value (Th=1). In this case, the cooking robot control apparatus 10 determines to perform the cooking suspension process.

However, cooking cannot be suspended at a freely set timing.

The cooking robot control apparatus 10 determines to suspend cooking at the following break point, that is, the following data analyzed and stored in the memory in step S12 above:

(c) cooking break point=after forming prepared meat mixture into patties.

(Step S21) [Time=18:30]

Step S21 is a processing step to be performed at the cooking break point stored in the memory in step S12 above.

That is, step S21 is performed when the cooking robot 11 progresses the cooking process and the “cooking break point=after forming prepared meat mixture into patties” is reached.

At this time (time=18:30), the cooking robot control apparatus 10 causes the cooking robot 11 to suspend cooking.

Note that the cooking robot control apparatus 10 sequentially updates the following two pieces of data stored in the memory, that is, the following pieces of time information as time passes:

(X) expected time to return home=19:30, and

(Y) expected time to complete cooking=19:00.

Although (X) expected time to return home=19:00 will not change unless new delay information or the like is input, (Y) expected time to complete cooking=19:00 will be delayed as the cooking suspension time elapses.

The cooking robot control apparatus 10 updates the above data (Y) stored in the memory such that

(Y) expected time to complete cooking=19:00+ elapsed suspension time.

(Step S22) [Time=18:45]

Processing in step S22 is performed when 15 minutes have passed (time=18:45) since the cooking was suspended in step S21.

The cooking robot control apparatus 10 continuously or intermittently receives the location information from the user terminal 20 even while the cooking is suspended, and checks the user's location as needed. Moreover, the cooking robot control apparatus 10 also receives operation information or the like on the transportation system to be used by the user, such as the train, from an external server such as the traffic information providing server, and acquires information on a delay of the train or the like, information on traffic congestion, and the like.

The cooking robot control apparatus 10 determines whether or not the expected time for the user to return home has been changed, on the basis of these pieces of information.

When 15 minutes have passed (time=18:45) after the suspension of cooking in step S21, the data (Y) stored in the memory are updated as follows with the elapse of the suspension time (15 minutes). Scheduled time=19:15

The cooking robot control apparatus 10 performs the determination process on the following data stored in the memory, that is, X (expected time to return home) and the data Y (expected time to complete cooking) according to the above (determination formula):

(X) expected time to return home=19:30, and

(Y) expected time to complete cooking: 19:15.

That is, whether or not the difference (time difference) between X (expected time to return home) and the data Y (expected time to complete cooking) is larger than the predetermined threshold value (Th) is determined according to the following (determination formula).

X−Y<Th (determination formula)

Note that as described above, the threshold value (Th) is set such that the threshold value (Th)=1 (min).

In the case of this setting,

X−Y=(19:30)−(19:15)=15.

Therefore, the following is not satisfied:

X−Y=15<1(Th).

That is, the (determination formula) is not satisfied.

In a case where the (determination formula) is not satisfied, the cooking robot control apparatus 10 continues the suspension of cooking.

That is, when 15 minutes have passed since the start of the suspension of cooking, the above (determination formula) is not satisfied, so that the suspension of cooking is continued.

(Steps S23 and S24) [Time=19:00]

Processing in steps S23 to S24 is performed when 30 minutes have passed (time=19:00) since the cooking was suspended in step S21.

When 30 minutes have passed (time=19:00) since the cooking was suspended in step S21, the data (Y) stored in the memory are updated as follows with the elapse of the suspension time (30 minutes).

(Y) Expected time to complete cooking=19:30

The cooking robot control apparatus 10 performs the determination process on the following data stored in the memory, that is, the data X (expected time to return home) and Y (expected time to complete cooking) according to the above (determination formula):

(X) expected time to return home=19:30, and

(Y) expected time to complete cooking: 19:30.

That is, whether or not the difference (time difference) between the data X (expected time to return home) and Y (expected time to complete cooking) is larger than the predetermined threshold value (Th) is determined according to the following (determination formula).

X−Y<Th (determination formula)

Note that here, as an example, the threshold value (Th) is set such that the threshold value (Th)=1, as described above.

In the case of this setting,

X−Y=(19:30)−(19:30)=0.

Therefore, the following is satisfied:

X−Y=0<1(Th).

That is, the (determination formula) is satisfied.

In a case where the (determination formula) is satisfied, the cooking robot control apparatus 10 stops the suspension of cooking, and resumes the cooking.

That is, when 30 minutes have passed since the start of the suspension of cooking, the above (determination formula) is satisfied, and the suspension of cooking is not continued and the cooking is resumed.

(Step S25) [Time=19:30]

Processing in step S25 is performed when 30 minutes have passed (time=19:30) since the cooking was resumed in step S24.

Thus far, the cooking robot 11 has cooked during the following two time periods, that is, for 45 minutes in total:

15 minutes from step S16 [time=18:15] to step S21 [time=18:30], and

30 minutes from step S24 [time=19:00] to step S25 [time=19:30].

That is, cooking has been performed for a period of time equal to the cooking time calculated in step S12 above as follows: cooking time=45 minutes.

As a result, the dish requested by the user [hamburgers for two people] is ready.

At the same timing [time=19:30], the user arrives home.

As a result, the user can immediately eat the freshly cooked dish.

In the sequence described with reference to FIGS. 1 to 3, the processing is started in steps S14 and S15 shown in FIG. 1 with the following settings.

(X) Expected time to return home=19:00

(Y) Expected time to complete cooking: 19:00

After the setting of the above, cooking is started at 18:15 in step S16 with an expected cooking time of 45 minutes.

After the start of cooking, the expected time to return home is updated such that (X) expected time to return home=19:00 is changed to (X) expected time to return home=19:30, on the basis of determination that the user will return home later than expected. As a result of this update process, the data X and Y stored in the memory are each set as follows:

(X) expected time to return home=19:30, and

(Y) expected time to complete cooking: 19:00.

The cooking robot control apparatus 10 determines to suspend cooking on the basis of the settings so that (Y) expected time to complete cooking: 19:00 coincides with (X) expected time to return home=19:30.

Suspension of cooking is performed by using, as a cooking break point, only the break point determined in advance on the basis of the recipe.

During the suspension process, the cooking robot control apparatus 10 sequentially checks whether or not the following determination formula is satisfied:

X−Y<Th (determination formula).

The cooking robot control apparatus 10 continues suspension of cooking while the above (determination formula) is not satisfied.

When time elapses after cooking is suspended at the break point, the data X and Y stored in the memory are each set as follows:

(X) expected time to return home=19:30, and

(Y) expected time to complete cooking: 19:30. As a result, it is confirmed that the following determination formula is satisfied:

X−Y<Th (determination formula).

Note that Th=1 (min).

When it is confirmed that this determination formula is satisfied, the suspension of cooking is stopped and cooking is resumed.

As a result of the resumption of cooking, cooking is completed in accordance with the following setting:

(Y) expected time to complete cooking: 19:30.

As a result, cooking will be completed at (X) expected time for the user to return home=19:30.

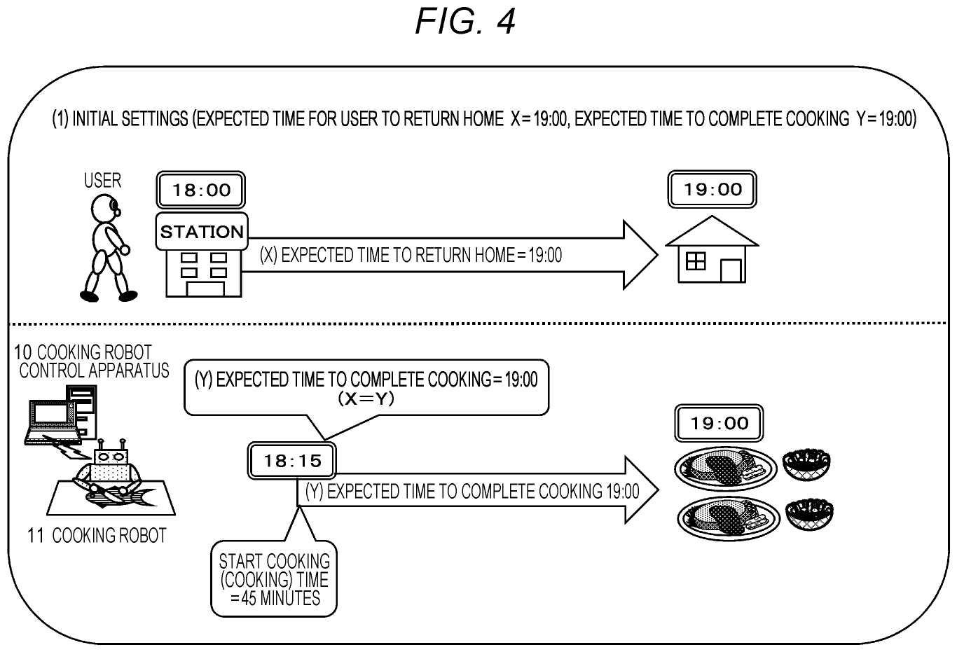

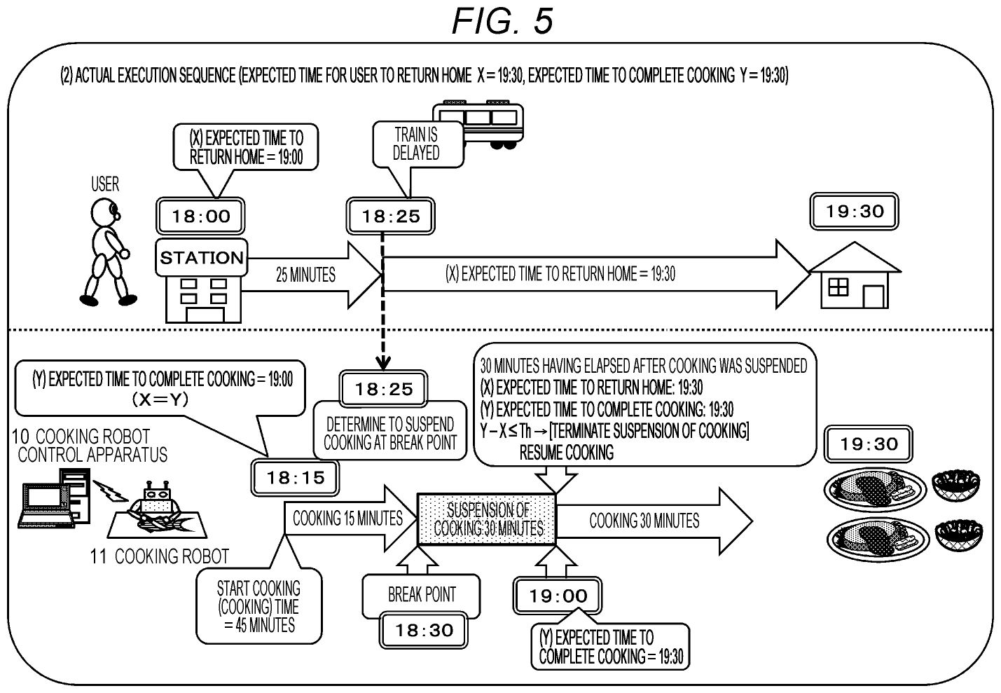

The difference between the initial setting of the sequence described with reference to FIGS. 1 to 3 and a final process sequence will be described with reference to FIGS. 4 and 5.

FIG. 4 is a diagram for describing the initial setting of the sequence described with reference to FIGS. 1 to 3. FIG. 5 is the diagram showing the final process sequence.

First, the initial setting of the sequence described with reference to FIGS. 1 to 3 will be described with reference to FIG. 4.

The user's behavior is shown in the upper part of FIG. 4, and a sequence for cooking to be performed by the cooking robot 11 under the control of the cooking robot control apparatus 10 is shown in the lower part of FIG. 4.

When the user terminal 20 notifies the cooking robot control apparatus 10 of the user's location at 18:00, that is, the time when the user enters the station shown in the upper part of FIG. 4, the cooking robot control apparatus 10 starts the process with the following initial settings:

(X) expected time to return home=19:00, and

(Y) expected time to complete cooking: 19:00.

That is, the cooking robot control apparatus 10 starts cooking at 18:15 with an expected cooking time of 45 minutes.

If there is no problem thereafter, everything proceeds in accordance with the following initial settings, and the cooking robot 11 completes cooking the dish at 19:00:

(X) expected time to return home=19:00, and

(Y) expected time to complete cooking: 19:00. The user returns home at 19:00, and can eat the freshly cooked dish.

However, in reality, there is a problem that the user may return home later than the initial expected time to return home. A process to be performed in this case is shown in FIG. 5.

When the user terminal 20 notifies the cooking robot control apparatus 10 of the user's location at 18:00, that is, the time when the user enters the station shown in the upper part of FIG. 4, the cooking robot control apparatus 10 starts the process with the following initial settings:

(X) expected time to return home=19:00, and

(Y) expected time to complete cooking: 19:00.

That is, the cooking robot control apparatus 10 starts cooking at 18:15 with an expected cooking time of 45 minutes.

After that, the expected time to return home is updated at 18:25 such that (X) expected time to return home=19:00 is changed to (X) expected time to return home=19:30, on the basis of determination that the user will return home later than expected. As a result of this update process, the data X and Y stored in the memory are each set as follows:

(X) expected time to return home=19:30, and

(Y) expected time to complete cooking: 19:00.

The cooking robot control apparatus 10 determines to suspend cooking on the basis of the settings so that (Y) expected time to complete cooking: 19:00 coincides with (X) expected time to return home=19:30.

Suspension of cooking is performed by using, as a cooking break point, only the break point determined in advance on the basis of the recipe.

The cooking robot 11 continues cooking, and the cooking break point is reached at 18:30, 15 minutes after the start of cooking.

This cooking break point is a point that the cooking robot control apparatus 10 has analyzed on the basis of the recipe before the start of cooking. That is, the cooking break point is a point that comes “after forming meat mixture into hamburger patties”.

When the “formation of meat mixture into hamburger patties” is completed at 18:30, 15 minutes after the start of cooking, the cooking robot control apparatus 10 causes the cooking robot 11 to suspend cooking.

During the suspension process, the cooking robot control apparatus 10 sequentially checks whether or not the following determination formula is satisfied:

X−Y<Th (determination formula).

The cooking robot control apparatus 10 continues suspension of cooking while the above (determination formula) is not satisfied.

Cooking is suspended at the break point and when it is 19:00, the data X and Y stored in the memory are each set as follows:

(X) expected time to return home=19:30, and

(Y) expected time to complete cooking: 19:30. As a result, it is confirmed that the following determination formula is satisfied:

X−Y<Th (determination formula).

Note that Th=1 (min).

When it is confirmed that this determination formula is satisfied, the suspension of cooking is stopped and cooking is resumed.

Cooking is resumed at 19:00 and performed for 30 minutes, that is, remaining time in the cooking time of 45 minutes.

With this process, cooking is completed in accordance with the following setting:

(Y) expected time to complete cooking: 19:30.

As a result, cooking is completed at (X) expected time for the user to return home=19:30.

[2. Regarding Configuration Example of Cooking Robot Control Apparatus]

Next, a configuration example of the cooking robot control apparatus 10 of the present disclosure will be described.

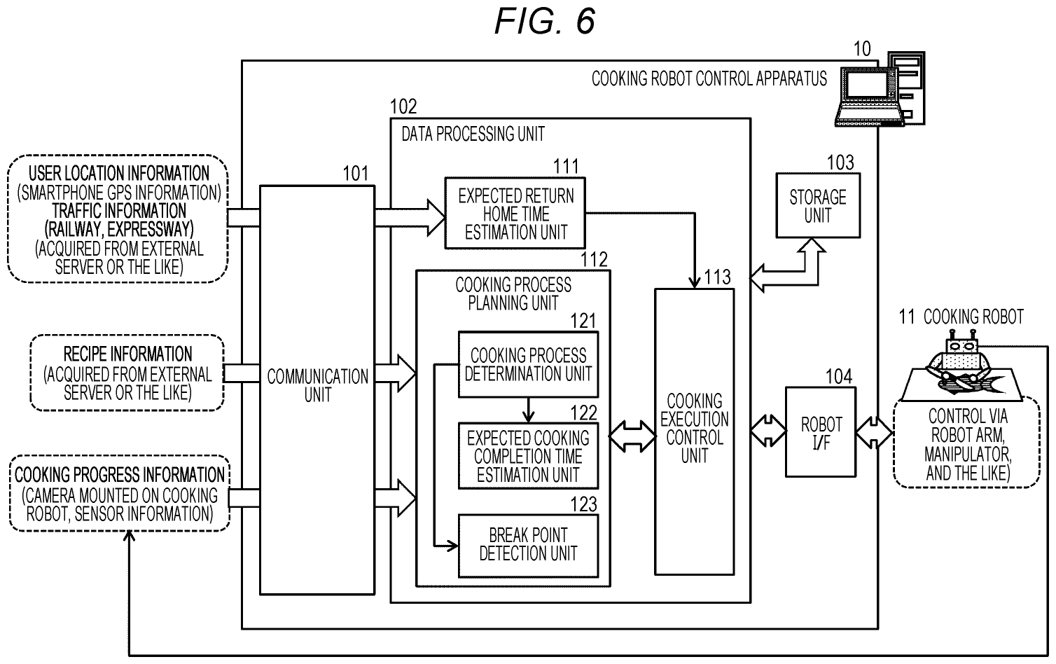

FIG. 6 is a block diagram showing a configuration example of the cooking robot control apparatus 10 of the present disclosure.

As shown in FIG. 6, the cooking robot control apparatus 10 includes a communication unit 101, a data processing unit 102, a storage unit 103, and a robot I/F 104.

Note that the data processing unit 102 includes an expected return home time estimation unit 111, a cooking process planning unit 112, and a cooking execution control unit 113.

Moreover, the cooking process planning unit 112 includes a cooking process determination unit 121, an expected cooking completion time estimation unit 122, and a break point detection unit 123.

The communication unit 101 performs communication with the user terminal of the user, external servers, and the cooking robot 11 to be controlled.

The communication unit 101 continuously or periodically receives, from the user terminal, user location information and the like in addition to a cooking request from the user.

Examples of the external servers include a traffic information providing server, a time information providing server, and a recipe information providing server.

The communication unit 101 receives, from the cooking robot 11, an image captured by a camera mounted on the cooking robot 11 and cooking process analysis information and the like analyzed by a control unit located inside the cooking robot 11.

Note that the cooking robot 11 is controlled via the robot I/F 104 in the example shown in FIG. 6, while the cooking robot 11 may be controlled by communication via the communication unit 101.

The data processing unit 102 includes the expected return home time estimation unit 111, the cooking process planning unit 112, and the cooking execution control unit 113.

The expected return home time estimation unit 111 estimates the expected time for the user to return home.

The expected return home time estimation unit 111 estimates the expected time for the user to return home by using, for example, the user location information received from the user terminal, and traffic information and operation state information on a train and the like received from the external server. The expected time for the user to return home that has been estimated is stored in the storage unit 103.

For example, the expected return home time estimation unit 111 estimates the following data (X) as shown in the example described above with reference to FIGS. 1 to 3, and stores the data (X) in the storage unit 103:

(X) expected time to return home=19:00.

The expected return home time estimation unit 111 acquires, for example, the user location information from the user terminal, and the traffic information and the operation state information on the train and the like from the external server as needed, and sequentially updates the expected time for the user to return home according to the acquired information.

Note that it is also possible to adopt a configuration in which the expected time for the user to return home is estimated or acquired by use of information provided by external servers, that is, external service providing servers such as a map information providing server and a traffic information providing server. In this case, externally acquired information is available without the need to cause the expected return home time estimation unit 111 to perform the estimation process.

The cooking process planning unit 112 includes the cooking process determination unit 121, the expected cooking completion time estimation unit 122, and the break point detection unit 123.

The cooking process determination unit 121 determines a cooking process with reference to recipe information acquired from the external recipe information providing server or recipe information stored in the storage unit 103. For example, the cooking process determination unit 121 acquires a recipe of a dish according to the user's request from a server or the storage unit 103, and determines a cooking process according to the acquired recipe.

The expected cooking completion time estimation unit 122 estimates the expected time to complete cooking by using the recipe information acquired from the external recipe information providing server or the storage unit 103 and cooking process information determined by the cooking process determination unit 121. The expected time to complete cooking that has been estimated is stored in the storage unit 103.

For example, the expected cooking completion time estimation unit 122 estimates the following data (Y) as shown in the example described above with reference to FIGS. 1 to 3, and stores the data (Y) in the storage unit 103:

(Y) expected time to complete cooking=19:00.

Note that in a case where the cooking execution control unit 113 performs control so as to cause the cooking robot 11 to suspend cooking, the expected cooking completion time estimation unit 122 performs a process for updating the expected time to complete cooking estimated and stored in the storage unit 103 with the elapse of the suspension time.

For example, the expected cooking completion time estimation unit 122 updates the data shown in the example described above with reference to FIGS. 1 to 3 such that the expected time to complete cooking (Y) is delayed with the elapse of the suspension time as follows:

(Y) expected time to complete cooking=19:00+ elapsed suspension time.

With this process, the latest expected time to complete cooking (Y) is always stored in the storage unit 103.

Note that it is also possible to adopt a configuration in which the expected time to complete cooking (Y) is estimated by use of information provided by an external server, that is, an external service providing server such as a recipe information providing server, as in the above-described process for estimating the expected time for the user to return home. In this case, externally acquired information is available without the need to cause the expected cooking completion time estimation unit 122 to perform the estimation process.

The break point detection unit 123 detects a point where suspension of cooking is allowed in the cooking process by using the recipe information acquired from the external recipe information providing server or the storage unit 103 and the cooking process information determined by the cooking process determination unit 121. Then, the break point detection unit 123 sets the point in the cooking process, and stores the point in the storage unit 103.

For example, a break point as shown in the example described above with reference to FIGS. 1 to 3 is set as follows and stored in the storage unit 103 in association with the cooking process:

break point=after forming prepared meat mixture into patties.

Note that the number of break points to be set is not limited to one, and may be two or more. For example, in the case of cooking a plurality of dishes, it is possible to set one or more break points in association with each of the dishes.

A specific example of the break point setting process will be described later.

The cooking execution control unit 113 performs control so as to cause the cooking robot 11 to perform the cooking process determined by the cooking process determination unit 121 of the cooking process planning unit 112. That is, the cooking execution control unit 113 causes the cooking robot 11 to perform cooking, by outputting a command to perform cooking according to the cooking process to the cooking robot 11.

Moreover, the cooking execution control unit 113 controls the start and suspension of cooking such that the expected time to complete cooking (Y) estimated by the expected cooking completion time estimation unit 122 coincides with the expected time for the user to return home (X) estimated by the expected return home time estimation unit 111, or such that the time difference (X−Y) is within or below the predetermined threshold value.

While causing the cooking robot 11 to perform cooking, the cooking execution control unit 113 suspends the cooking as necessary so that the time difference (X−Y) between the expected time to return home (X) and the expected time to complete cooking (Y) is less than the predetermined threshold value (for example, 0, 5 minutes, or 10 minutes).

Note that suspension of cooking is performed only at the break point determined by the cooking break point detection unit 123.

The robot I/F 104 controls a robot arm and a manipulator to cause the cooking robot 11 to perform cooking, by outputting a command to perform cooking according to the cooking process output by the cooking execution control unit 113 to the cooking robot 11. Furthermore, in a case where cooking is suspended, the robot I/F 104 causes the cooking robot 11 to temporarily stop cooking.

The cooking robot 11 includes various sensors such as a camera that images the state of cooking, a sensor that distinguishes between cooking ingredients, and a sensor that measures the temperature of the food or the like being cooked. Pieces of information acquired by these sensors are input to the robot I/F 104 or input to the data processing unit 102 via the communication unit 101, and is used for controlling execution of cooking.

As described above, the following pieces of data are each recorded in the storage unit 103:

the expected time for the user to return home (X) estimated by the expected return home time estimation unit 111, and

the expected time to complete cooking (Y) estimated by the expected cooking completion time estimation unit 122.

Moreover, the following pieces of information are also recorded in the storage unit 103:

the cooking process information determined by the cooking process determination unit 121,

break point information set by the break point detection unit 123, and

the threshold value (Th) for comparing with the difference (X−Y) between the expected time to return home (X) and the expected time to complete cooking (Y).

Note that the following pieces of data stored in the storage unit 103 are each sequentially updated according to the situation:

the expected time for the user to return home (X) estimated by the expected return home time estimation unit 111, and

the expected time to complete cooking (Y) estimated by the expected cooking completion time estimation unit 122.

[3. Regarding Sequence for Processing to be Performed by Cooking Robot Control Apparatus of Present Disclosure]

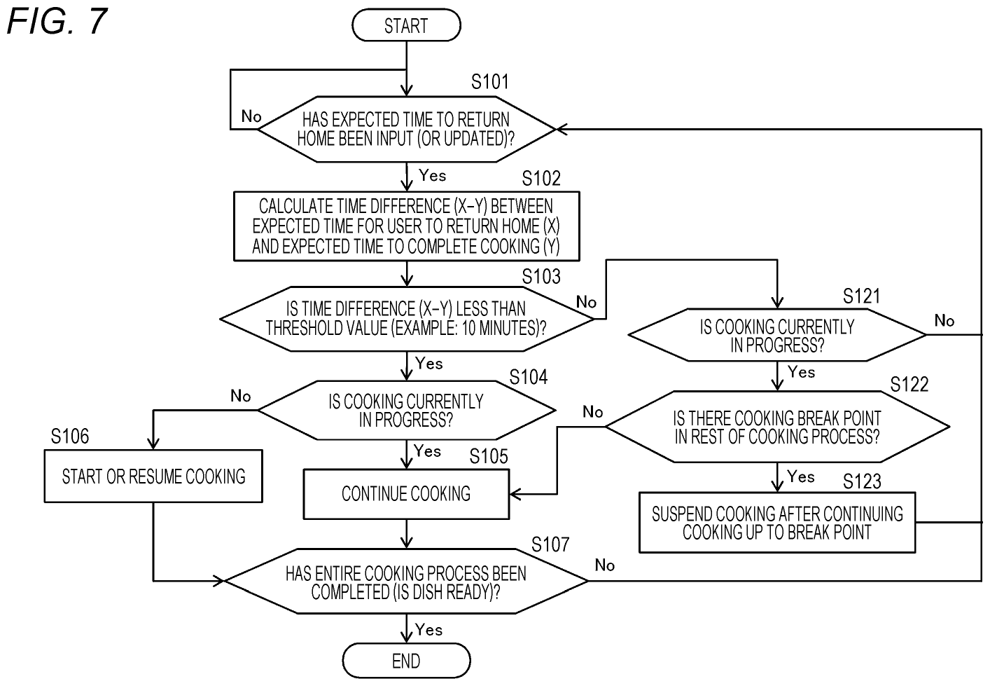

Next, a sequence for the processing to be performed by the cooking robot control apparatus 10 of the present disclosure will be described with reference to a flowchart shown in FIG. 7.

Note that the processing according to the flowchart shown in FIG. 7 can be performed according to a program stored in the storage unit of the cooking robot control apparatus 10 corresponding to the information processing apparatus of the present disclosure, and can be performed as, for example, program execution processing by a processor such as a CPU having a program execution function.

Note that the flow shown in FIG. 7 is a flow for describing the sequence for processing to be performed after completion of the processing of steps S11 and S12 shown in FIG. 1 in the sequence describing FIGS. 1 to 3 above. That is, the flow shown in FIG. 7 is a flow for describing the process sequence for processing to be performed after the recipe acquisition process is performed on the basis of the cooking request from the user, the cooking process is determined on the basis of the acquired recipe, and cooking time is definitely fixed.

Hereinafter, processing in each step of the flow shown in FIG. 7 will be described.

(Step S101)

First, in step S101, it is determined whether the expected time for the user to return home (X) has been input (recorded) into the storage unit 103 or has been updated.

Note that in the process described above with reference to FIGS. 1 to 3, the cooking robot control apparatus 10 receives, from the user terminal 20, location information indicating that the user has arrived at a point that makes it possible to determine that the user is heading home, that is, a station where the user takes a train for returning home, and estimates the expected time for the user to return home (X) on the basis of the user location information.

The return home schedule estimation unit 111 of the cooking robot control apparatus 10 shown in FIG. 6 performs a process for estimating the initial expected time for the user to return home (X) and a process for storing the initial expected time for the user to return home (X) in the storage unit 103 when, for example, it has been confirmed that the user is heading home. The expected time to return home (X) is stored as an initial setting value in the storage unit 103.

Note that it is also possible for the user to input this initial setting value into the cooking robot control apparatus 10 to record the initial setting value in the storage unit 103 before going out.

Even after confirming that the user is heading home, the cooking robot control apparatus 10 sequentially receives the location information from the user terminal 20 and the traffic information from the external server such as the traffic information providing server. On the basis of these pieces of received data, the cooking robot control apparatus 10 performs the process of updating the expected time for the user to return home (X), and stores the updated data in the storage unit 103.

In step S101, it is determined whether the expected time for the user to return home (X) has been recorded in the storage unit or has been updated.

In a case where the expected time to return home (X) has not been recorded in the storage unit or updated, the cooking robot control apparatus 10 stays on standby.

In a case where the expected time to return home (X) has been recorded in the storage unit or has been updated, the process proceeds to step S102.

(Step S102)

Next, in step S102, the data processing unit 102 of the cooking robot control apparatus 10 calculates the time difference (X−Y) between the expected time for the user to return home (X) and the expected time to complete cooking (Y).

Note that in a case where the expected time to complete cooking (Y) is not stored in the storage unit 103 at this point of time, the data processing unit 102 sets the expected time to complete cooking (Y) such that the expected time to complete cooking (Y) coincides with the expected time for the user to return home (X), and the data processing unit 102 also calculates cooking start time on the basis of the expected time to complete cooking (Y) set in this way, and stores the calculated cooking start time in the storage unit 103. The expected time to complete cooking (Y) is also an initial setting value.

Processing in step S102 is performed after both the following pieces of data are stored in the storage unit 103:

the expected time for the user to return home (X), and

the expected time to complete cooking (Y).

In step S102, the cooking robot control apparatus 10 calculates the time difference (X−Y) between the expected time for the user to return home (X) and the expected time to complete cooking (Y).

The cooking execution control unit 113 of the data processing unit 102 of the cooking robot control apparatus 10 acquires the expected time for the user to return home (X) estimated by the expected return home time estimation unit 111, and the expected time to complete cooking (Y) estimated by the expected cooking completion time estimation unit 122, and calculates the time difference between these two pieces of data as follows:

X−Y.

(Step S103)

Next, in step S103, the cooking execution control unit 113 of the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

In a case where the above determination formula is satisfied, that is, in a case where the time difference (X−Y) between the expected time for the user to return home (X) and the expected time to complete cooking (Y) is less than the predetermined threshold value (Th: for example, 10 minutes), the process proceeds to step S104.

Meanwhile, in a case where the above determination formula is not satisfied, that is, in a case where the time difference (X−Y) between the expected time for the user to return home (X) and the expected time to complete cooking (Y) is not less than the predetermined threshold value (Th: for example, 10 minutes), the process proceeds to step S121.

Note that as described above, the above determination formula is an example. The determination formula can be set in various ways, and can be freely set by the user.

(Steps S104 to S106)

X−Y<Th (determination formula)

In a case where the above determination formula is satisfied, that is, in a case where the time difference (X−Y) between the expected time for the user to return home (X) and the expected time to complete cooking (Y) is less than the predetermined threshold value (Th: for example, 10 minutes), the process proceeds to step S104.

In step S104, the cooking execution control unit 113 of the cooking robot control apparatus 10 determines whether or not the cooking robot 11 is currently performing cooking.

In a case where cooking is in progress, the process proceeds to step S105 to continue cooking.

Meanwhile, in a case where the cooking robot 11 is not performing cooking, the process proceeds to step S106 to start or resume cooking.

This processing is either processing for starting cooking at the start time of cooking or processing for stopping suspension of cooking and resuming cooking.

(Step S107)

While the cooking robot 11 is performing cooking in step S105 or step S106, processing of step S107 is performed.

In step S107, it is determined whether or not the entire cooking process has been completed.

In a case where it is determined that the entire cooking process has been completed, the process is terminated.

Meanwhile, in a case where the entire cooking process has not been completed, the process returns to step S101 to repeat the processing in step S101 and the subsequent steps.

(Step S121)

Next, a description will be given of processing in step S121 and the subsequent steps to be performed in a case where the following determination formula is not satisfied in step S103 described above, that is, in a case where the time difference (X−Y) between the expected time for the user to return home (X) and the expected time to complete cooking (Y) is not less than the predetermined threshold value (Th: for example, 10 minutes):

X−Y<Th (determination formula).

In step S121, the cooking execution control unit 113 of the data processing unit 102 of the cooking robot control apparatus 10 determines whether or not the cooking robot 11 is currently performing cooking.

In a case where cooking is in progress, the process proceeds to step S122.

Meanwhile, in a case where the cooking robot 11 is not performing cooking, the process returns to step S101 to repeatedly perform the processing in step S101 and the subsequent steps.

(Step S122)

In a case where it is determined in step S121 that the cooking robot 11 is currently performing cooking, the process proceeds to step S122.

In step S122, it is determined whether or not there is a break point in the rest of the cooking process.

This break point detection process is performed by the break point detection unit 123.

In a case where there is a break point in the rest of the cooking process, the process proceeds to step S123.

Meanwhile, in a case where there is no break point in the rest of the cooking process, the process proceeds to step S105 to continue cooking. In this case, cooking cannot be suspended because there is no break point in the rest of the cooking process. In this case, the dish will be ready earlier than the time when the user returns home.

(Step S123)

In a case where there is a break point in the rest of the cooking process in step S122, the process proceeds to step S123.

In step S123, cooking is suspended at a break point after cooking is continued up to the break point, and the process returns to step S101 to repeat the processing in step S101 and the subsequent steps.

The process to be performed by the cooking robot control apparatus 10 of the present disclosure has been described above according to the flow shown in FIG. 7.

The process to be performed according to the flowchart shown in FIG. 7 includes various types of different processing to be performed according to determination results in a plurality of determination steps included in the flow.

For example, each of the following processes is performed according to the flowchart shown in FIG. 7.

(1) Cooking start determination process and cooking start process

(2) Process to be performed in a case where there is no change in the expected time for the user to return home (X) initially set

(3) Process to be performed in the case of suspending cooking

(4) Process to be performed during suspension of cooking

(5) Process for resuming cooking after suspension of cooking

(6) Process to be performed in a case where there is no cooking break point in the rest of the cooking process, the cooking break point making the difference between the expected time to complete cooking (Y) and the expected time to return home (X) equal to or less than the threshold value (Th)

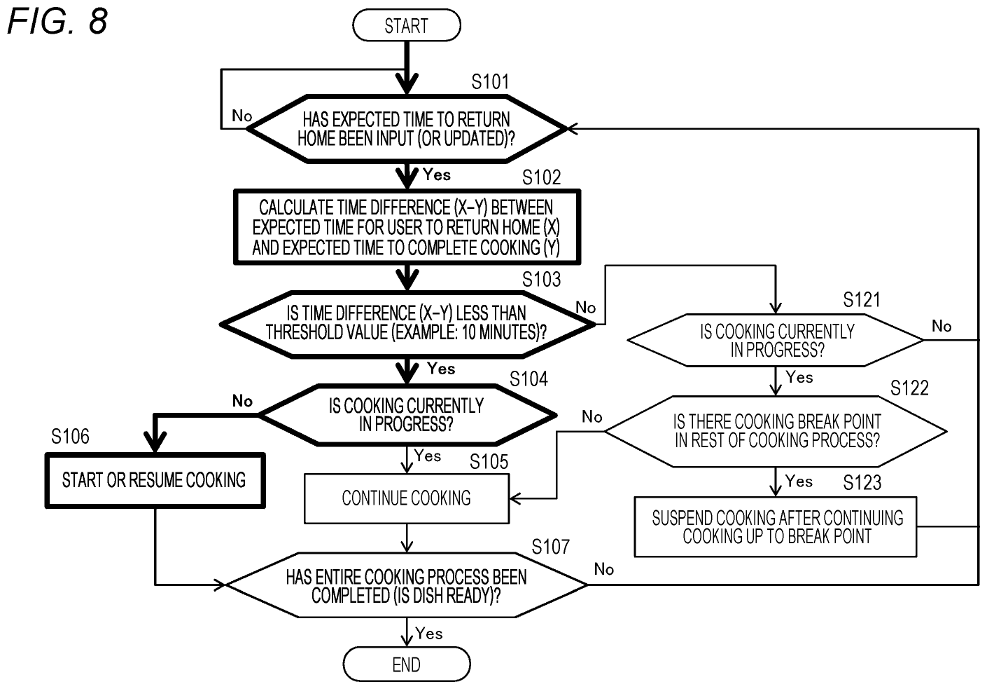

Hereinafter, steps to be performed in a case where these processes (1) to (6) are performed will be described with reference to FIG. 8 and subsequent drawings.

The flowcharts shown in FIGS. 8 to 13 show the same flow as the flowchart shown in FIG. 7, and only sequence portions for each of the processes (1) to (6) above are indicated by thick lines.

Hereinafter, each of the processes (1) to (6) above will be described.

(1) Cooking start determination process and cooking start process

First, a sequence to be applied to a case where the “(1) cooking start determination process and cooking start process” are performed will be described with reference to the flow shown in FIG. 8.

As shown in FIG. 8, the process sequence to be applied to a case where the “(1) cooking start determination process and cooking start process” are performed is a sequence in which steps are performed as follows:

step S101 (Yes)->step S102->step S103 (Yes)->step S104 (No)->step S106.

First, it is determined in step S101 that the expected time for the user to return home (X) has been input to the storage unit or has been updated, and the process proceeds to step 3102.

Next, in step S102, the cooking robot control apparatus 10 calculates the time difference (X−Y) between the expected time for the user to return home (X) and the expected time to complete cooking (Y).

Moreover, in step S103, the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

In the present example, this is a process of starting cooking, and the above determination formula is satisfied.

When it is confirmed that the above determination formula is satisfied, it is determined, in step S104, whether or not the cooking robot 11 is currently performing cooking.

In the present example, the cooking robot 11 is not performing cooking because cooking has not yet been started. In this case, the process proceeds to step S106 to cause the cooking robot 11 to start cooking.

When cooking is started, this series of processing steps is performed.

(2) Process to be performed in a case where there is no change in the expected time for the user to return home (X) initially set

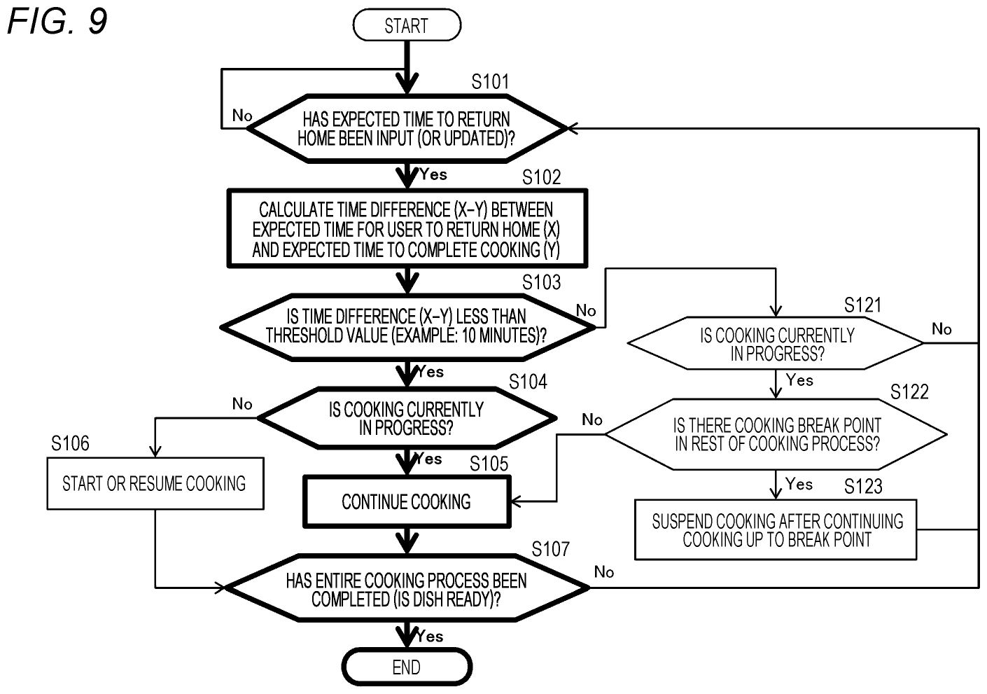

Next, a sequence to be applied to a case where the “(2) process to be performed in a case where there is no change in the expected time for the user to return home (X) initially set” is performed will be described with reference to the flow shown in FIG. 9.

As shown in FIG. 9, the process sequence to be applied to a case where the “(2) process to be performed in a case where there is no change in the expected time for the user to return home (X) initially set” is performed is a sequence in which steps are performed as follows:

step S101 (Yes)->step S102->step S103 (Yes)->step S104 (Yes)->step S105->step S107 (Yes)->END.

Note that the present example is based on the assumption that cooking has already been started on the basis of the initial setting, that is, the setting in which the expected time to complete cooking (Y) coincides with the expected time for the user to return home (X).

First, it is determined in step S101 that the expected time for the user to return home (X) has been input to the storage unit or has been updated, and the process proceeds to step S102.

Next, in step S102, the cooking robot control apparatus 10 calculates the time difference (X−Y) between the expected time for the user to return home (X) and the expected time to complete cooking (Y).

Moreover, in step S103, the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

As described above, in the present example, cooking has already been started on the basis of the initial setting in which the expected time to complete cooking (Y) coincides with the expected time for the user to return home (X). Thus, the above determination formula is satisfied.

When it is confirmed that the above determination formula is satisfied, it is determined, in step S104, whether or not the cooking robot 11 is currently performing cooking.

In the present example, cooking is being performed. Thus, the process proceeds to step S105 to cause the cooking robot 11 to continue cooking.

As a result of thus continuing cooking, cooking is completed and the dish is ready at the expected time to complete cooking (Y). This timing coincides with the expected time for the user to return home (X), or there is a time difference less than the predetermined threshold value (Th).

In a case where there is no change in the expected time for the user to return home (X) initially set, this series of processing steps is performed.

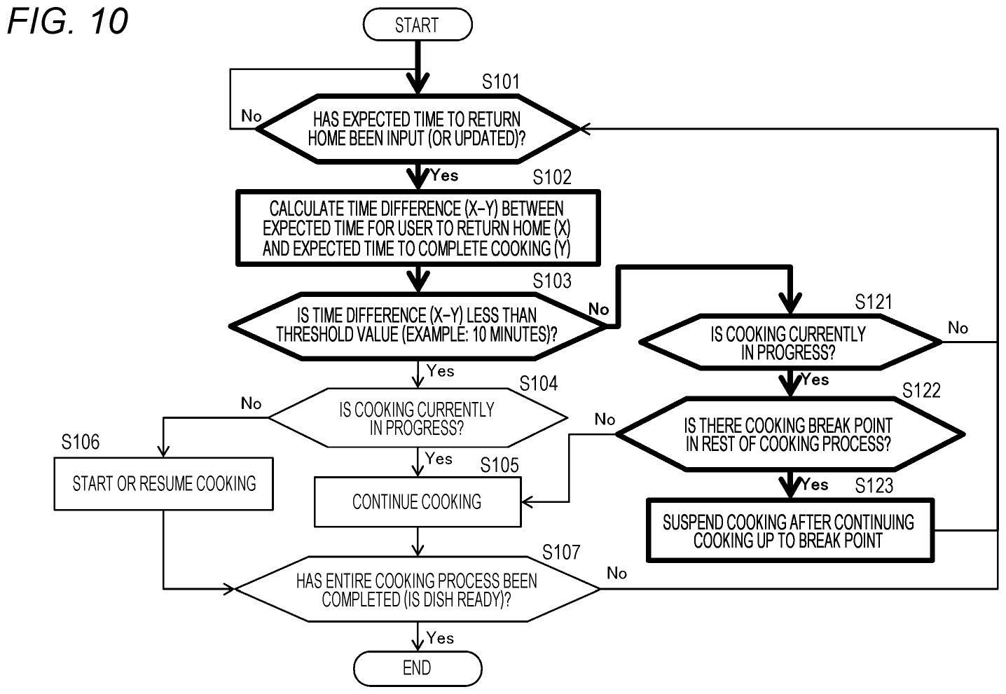

Next, a sequence to be applied to a case where the “(3) process to be performed in the case of suspending cooking” is performed will be described with reference to the flow shown in FIG. 10.

As shown in FIG. 10, the process sequence to be applied to a case where the “(3) process to be performed in the case of suspending cooking” is performed is a sequence in which steps are performed as follows:

step S101 (Yes)->step S102->step S103 (No)->step S121 (Yes)->step S122 (Yes)->step S123.

Note that the present example is based on the assumption that cooking has already been started on the basis of the initial setting, that is, the setting in which the expected time to complete cooking (Y) coincides with the expected time for the user to return home (X), and then the expected time for the user to return home (X) has been updated such that the expected time for the user to return home (X) is delayed.

First, it is determined in step S101 that the expected time for the user to return home (X) has been updated, and the process proceeds to step S102. The present example is based on the assumption that the expected time for the user to return home (X) has been updated to be later than the initial setting.

Next, in step S102, the cooking robot control apparatus 10 calculates the time difference (X−Y) between the expected time for the user to return home (X) and the expected time to complete cooking (Y).

Moreover, in step S103, the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

As described above, the present example is based on the assumption that the expected time for the user to return home (X) has been updated to be later than the initial setting. Therefore, the above (determination formula) is not satisfied.

When it is confirmed that the above determination formula is not satisfied, the process proceeds to step S121.

In step S121, it is determined whether or not the cooking robot 11 is currently performing cooking.

In the present example, cooking is being performed. Thus, the process proceeds to step S122 to determine whether or not there is a break point in the rest of the cooking process.

The present example is based on the assumption that there is a break point. In this case, the process proceeds to step S123, and cooking is continued up to the break point and then suspended at the break point.

In a case where cooking is suspended, these processing steps are performed.

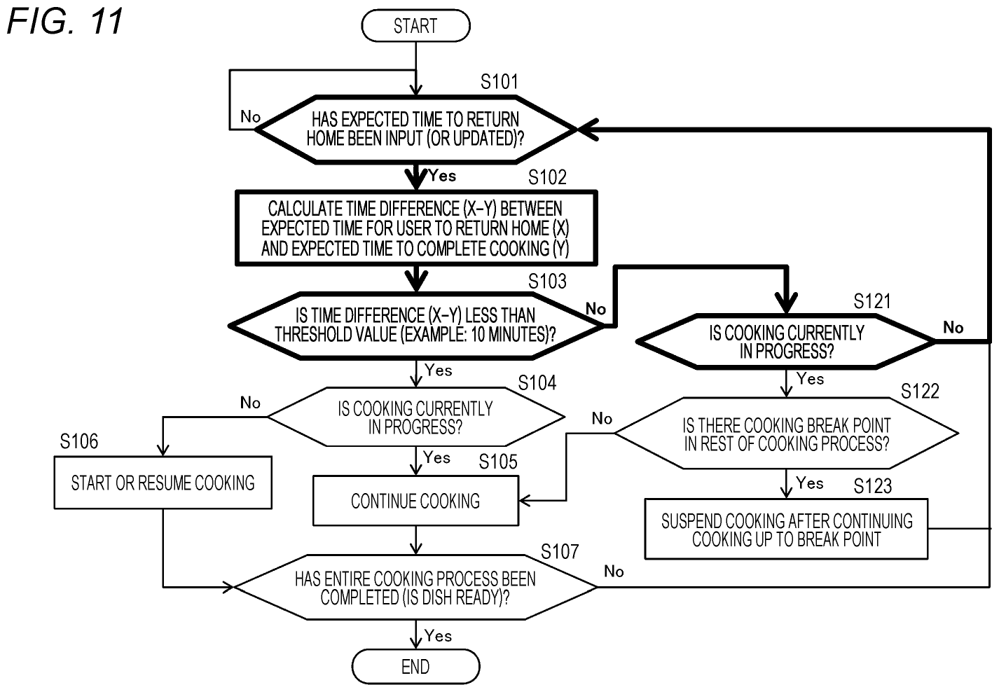

Next, a sequence to be applied to a case where the “(4) process to be performed during suspension of cooking” is performed will be described with reference to the flow shown in FIG. 11.

As shown in FIG. 11, the process sequence to be applied to a case where the “(4) process to be performed during suspension of cooking” is performed is a sequence in which steps are repeatedly performed as follows:

step S101 (Yes)->step S102->step S103 (No)->step 3121 (No)->step S101.

Note that the present example is based on the assumption that cooking has already been suspended.

First, it is determined in step S101 that the expected time for the user to return home (X) has been updated, and the process proceeds to step S102. The present example is based on the assumption that the expected time for the user to return home (X) has been updated to be later than the initial setting.

Next, in step S102, the cooking robot control apparatus 10 calculates the time difference (X−Y) between the expected time for the user to return home (X) and the expected time to complete cooking (Y).

Moreover, in step S103, the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

As described above, in the present example, cooking is currently suspended, that is, the expected time for the user to return home (X) has been updated to be later than the initial setting. Therefore, the above (determination formula) is not satisfied.

When it is confirmed that the above determination formula is not satisfied, the process proceeds to step S121.

In step S121, it is determined whether or not the cooking robot 11 is currently performing cooking.

In the present example, cooking is being suspended. Therefore, the process returns to step S101, and steps are repeatedly performed as follows:

step S101 (Yes)->step S102->step S103 (No)->step S121 (No)->step S101,

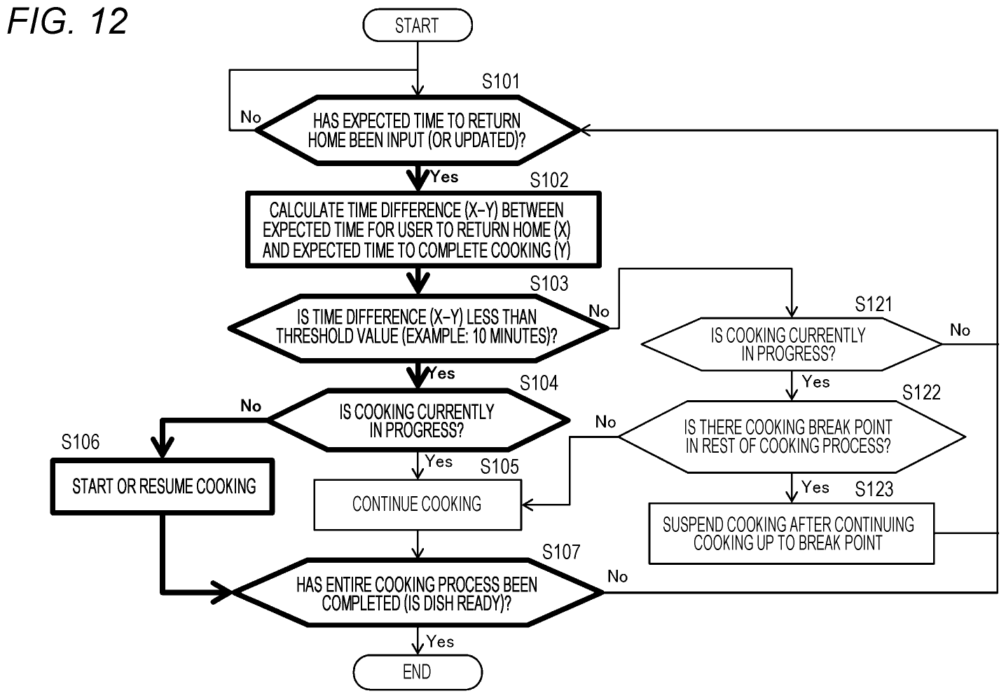

Next, a sequence to be applied to a case where the “(5) process for resuming cooking after suspension of cooking” is performed will be described with reference to the flow shown in FIG. 12.

As shown in FIG. 12, the process sequence to be applied to a case where the “(5) process for resuming cooking after suspension of cooking” is performed is a sequence in which steps are performed as follows:

step 3101 (Yes)->step 3102->step S103 (Yes)->step S104 (No)->step S106->step S107.

Note that the present example is based on the assumption that cooking has already been suspended.

First, it is determined in step S101 that the expected time for the user to return home (X) has been updated, and the process proceeds to step S102. The present example is based on the assumption that the expected time for the user to return home (X) has been updated to be later than the initial setting.

Next, in step S102, the cooking robot control apparatus 10 calculates the time difference (X−Y) between the expected time for the user to return home (X) and the expected time to complete cooking (Y).

Moreover, in step S103, the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

As described above, in the present example, cooking is currently suspended, that is, the expected time for the user to return home (X) has been updated to be later than the initial setting.

However, the “expected time to complete cooking (Y)” stored in the storage unit 103 is also updated with the passage of time as the suspension time elapses That is, the expected time to complete cooking (Y) is updated such that the elapsed suspension time is added to the original expected time to complete cooking (Y) as follows:

the expected time to complete cooking (Y)=Y (initial setting)+elapsed suspension time.

As a result, the timing is reached at which the following determination formula is satisfied:

X−Y<Th (determination formula).

The present example is a process to be performed at this timing.

When the above determination formula is satisfied, a determination of “Yes” is made in step S103, and the process proceeds to step S104. In step S104, it is determined whether or not the cooking robot 11 is currently performing cooking.

In the present example, cooking is being suspended. Thus, a determination of “No” is made in step S104. Accordingly, the process proceeds to step S106, and cooking is resumed in step S106.

As a result of thus resuming cooking, cooking is completed and the dish is ready at the expected time to complete cooking (Y) represented as follows:

the expected time to complete cooking (Y)=Y (initial setting)+suspension time. This timing coincides with the expected time for the user to return home (X) that has been updated, or there is a time difference less than the predetermined threshold value (Th).

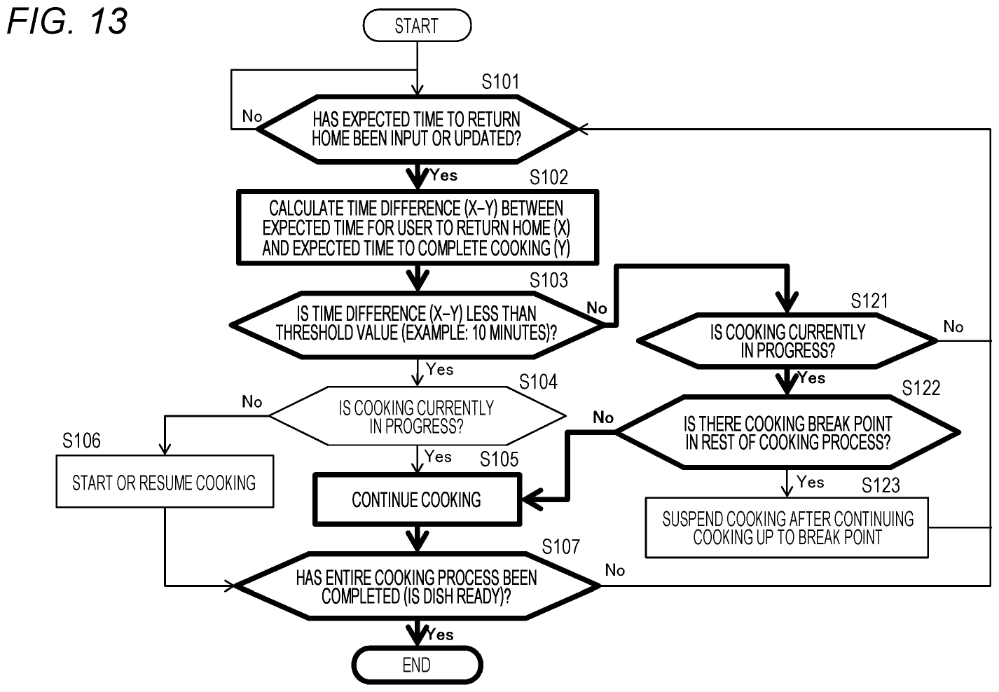

Next, a sequence to be applied to a case where the “(6) process to be performed in a case where there is no cooking break point in the rest of the cooking process, the cooking break point making the difference between the expected time to complete cooking (Y) and the expected time to return home (X) equal to or less than the threshold value (Th)” is performed will be described with reference to the flow shown in FIG. 13.

As shown in FIG. 13, the process sequence to be applied to a case where the “(6) process to be performed in a case where there is no cooking break point in the rest of the cooking process, the cooking break point making the difference between the expected time to complete cooking (Y) and the expected time to return home (X) equal to or less than the threshold value (Th)” is performed is a sequence in which steps are performed as follows:

step S101 (Yes)->step S102->step S103 (No)->step S121 (Yes)->step S122 (No)->step S105->step S107 (Yes)->END.

Note that the present example is based on the assumption that cooking has been started on the basis of the initial setting, that is, the setting in which the expected time to complete cooking (Y) coincides with the expected time for the user to return home (X), and then the expected time for the user to return home (X) has been updated such that the expected time for the user to return home (X) is delayed.

First, it is determined in step S101 that the expected time for the user to return home (X) has been updated, and the process proceeds to step 3102. The present example is based on the assumption that the expected time for the user to return home (X) has been updated to be later than the initial setting.

Next, in step S102, the cooking robot control apparatus 10 calculates the time difference (X−Y) between the expected time for the user to return home (X) and the expected time to complete cooking (Y).

Moreover, in step S103, the cooking robot control apparatus 10 determines whether or not the time difference (X−Y) between the expected time for the user to return home (X) and the expected time to complete cooking (Y) is less than the predetermined threshold value (Th: for example, 10 minutes).

That is, it is determined whether or not the following determination formula is satisfied:

X−Y<Th (determination formula).

As described above, the present example is based on the assumption that the expected time for the user to return home (X) has been updated to be later than the initial setting. Therefore, the above (determination formula) is not satisfied.

When it is confirmed that the above determination formula is not satisfied, the process proceeds to step S121.

In step S121, it is determined whether or not the cooking robot 11 is currently performing cooking.

In the present example, cooking is being performed. Thus, the process proceeds to step S122 to determine whether or not there is a break point in the rest of the cooking process.

The present example is based on the assumption that there is no break point. In this case, the process proceeds to step S105 to continue cooking.

In this case, cooking is continued without suspension and cooking is completed.

As a result, the cooking of the dish is completed while the following determination formula is not satisfied:

X−Y<Th (determination formula).

The cooking of the dish is completed in a state where the time difference (X−Y) between the expected time for the user to return home (X) and the expected time to complete cooking (Y) is not less than the predetermined threshold value (Th: for example, 10 minutes).

That is, the dish is ready earlier than the expected time for the user to return home (X).

This occurs because only a predetermined point is used as a break point.

[4. Regarding Process for Determining Cooking Process and Cooking Break Point]

Next, a description will be given of a process for determining the cooking process and the cooking break points, to be performed by the cooking robot control apparatus 10 of the present disclosure.

As described above with reference to FIG. 6, the cooking process planning unit 112 of the data processing unit 102 of the cooking robot control apparatus 10 of the present disclosure includes the break point detection unit 123.

The break point detection unit 123 detects and sets a point where suspension of cooking is allowed in the cooking process by using the recipe information acquired from the external recipe information providing server or the storage unit 103 and the cooking process information determined by the cooking process determination unit 121.

For example, a break point as shown in the example described above with reference to FIGS. 1 to 3 is set as follows:

break point=after forming prepared meat mixture into patties.

Note that the number of break points to be set is not limited to one, and may be two or more. For example, in the case of cooking a plurality of dishes, it is possible to set a break point in association with each of the dishes.

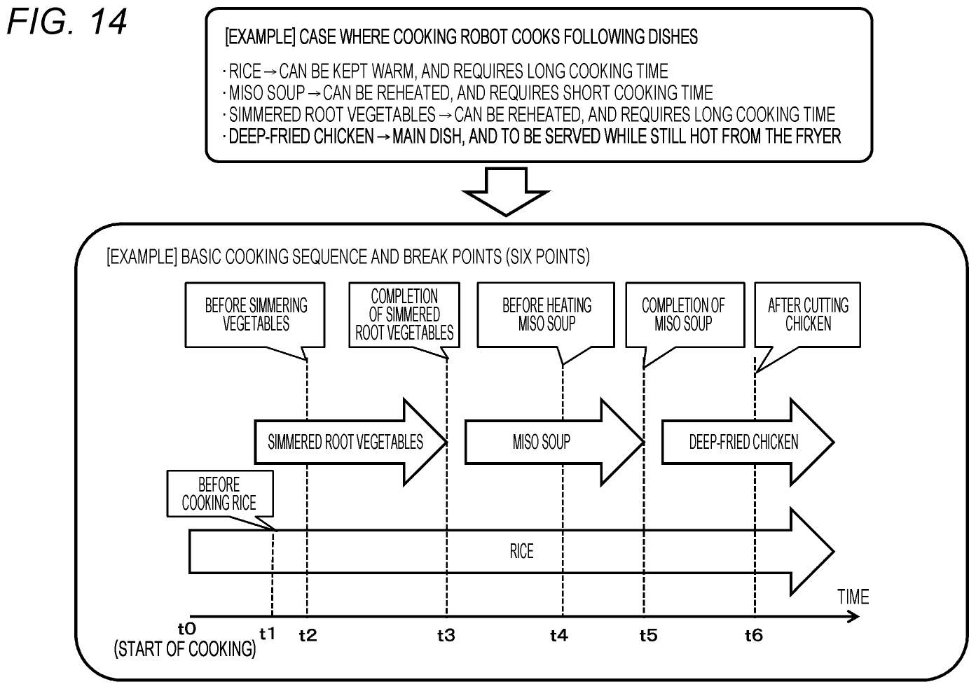

A specific example of the break point detection process will be described with reference to FIG. 14.

FIG. 14 shows an example of a case where the cooking robot 11 cooks a plurality of dishes as follows.

(1) Rice

(2) Miso soup

(3) Simmered root vegetables

(4) Deep-fried chicken

The characteristics of these four dishes are as follows.

(1) Rice=can be kept warm, and requires long cooking time

(2) Miso soup=can be reheated, and requires short cooking time

(3) Simmered root vegetables=can be reheated, and requires long cooking time

(4) Deep-fried chicken=main dish, and to be desirably served while still hot from the fryer

The break point detection unit 123 analyzes these characteristics by using the recipe information acquired from the external recipe information providing server or the storage unit 103 and the cooking process information determined by the cooking process determination unit 121.

In a case where a break point can be acquired from the recipe information, the break point detection unit 123 acquires the break point. In a case where no break point can be acquired from the recipe information, the break point detection unit 123 detects, for each dish, a point where suspension of cooking is allowed during a cooking process by using, for example, the result of analyzing the characteristics of each of the above-described dishes.

A diagram in the lower part of FIG. 14 shows examples of a cooking process determined by the cooking process determination unit 121 and break points set by the break point detection unit 123 on the cooking process. The break point detection unit 123 sets a break point for each dish. For example, the break point detection unit 123 sets break points as follows.

(1) Rice=before cooking rice (t1),

(2) Simmered root vegetables=before cutting vegetables (t2), and at the completion of simmered root vegetables (t3)

(3) Miso soup=before heating miso soup (t4), and at the completion of miso soup (t5)

(4) Deep-fried chicken=after cutting chicken (t6)

Note that the respective cooking break points are recorded in the storage unit 103 in association with information on elapsed time (t1 to t6) from the cooking start time set to t0.

The break point detection unit 123 detects a break point for each dish on the basis of the recipe information or information on the characteristics of the dishes in this way, and stores the detected break points in the storage unit 103.

The break point information is stored in the storage unit 103 together with the cooking process information determined by the cooking process determination unit 121.

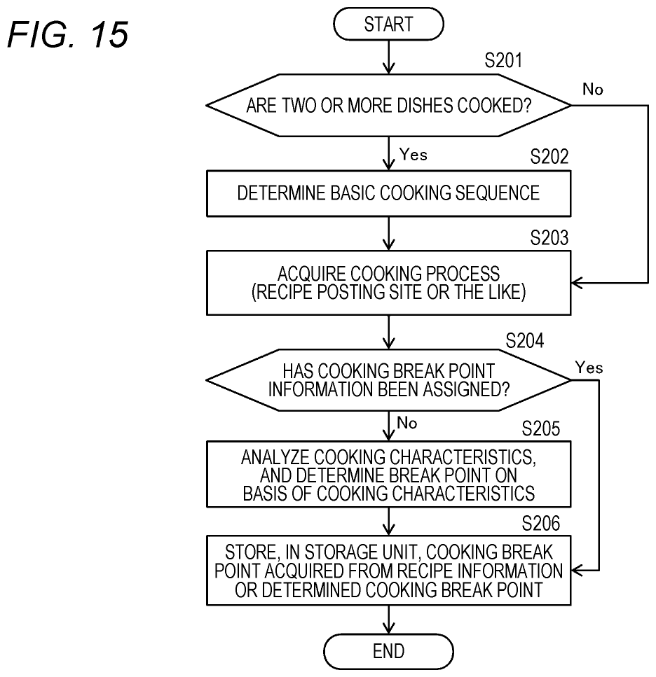

Next, referring to a flowchart shown in FIG. 15, a description will be given of a process sequence for a cooking process determination process and a break point determination process to be respectively performed by the cooking process determination unit 121 and the break point detection unit 123 of the cooking process planning unit 120 of the cooking robot control apparatus 10 of the present disclosure.

Note that the processing according to the flowcharts shown in FIG. 15 can be performed according to a program stored in the storage unit of the cooking robot control apparatus 10 corresponding to the information processing apparatus of the present disclosure, and can be performed as, for example, program execution processing by a processor such as a CPU having a program execution function.

Hereinafter, processing in each step of the flow shown in FIG. 15 will be described.

(Step S201)

First, in step S201, the cooking process determination unit 121 determines whether or not two or more dishes, that is, a plurality of dishes is included in a request from the user.

In a case where a plurality of dishes is to be cooked, the process proceeds to step S202.

Meanwhile, in a case where a single dish is to be cooked, the process proceeds to step S203.

(Step S202)

In a case where a plurality of dishes is to be cooked, the cooking process determination unit 121 determines a basic cooking sequence in step S202. That is, the cooking process determination unit 121 determines, for example, the order in which a plurality of dishes is cooked.

For example, the order is determined such that a dish that does not taste good when cold or a dish that cannot be easily reheated is cooked last. The sequence is determined such that a dish that tastes good even when cold or a dish that can be reheated (garnish or the like) is cooked first.

For example, performed is a process of setting the cooking sequence and the like described above with reference to FIG. 14.

Note that the simmered dish, miso soup, and deep-fried chicken are cooked one by one in order in the sequence described with reference to FIG. 14, while the sequence may be set such that a plurality of dishes is cooked simultaneously.

For example, vegetables for the simmered dish and vegetables for the miso soup are prepared at the same time. For example, the miso soup is cooked while chicken is seasoned.

In a case where the cooking robot 11 can cook the dishes simultaneously, a simultaneous cooking sequence is determined in step S202.

Note that even in a case where a plurality of dishes is cooked simultaneously, a cooking break point is provided at which all the cooking steps are suspended. For example, in the above example, a break point is provided after preparation of the vegetables for the simmered dish and the miso soup.

Note that the cooking process determination unit 121 holds, in advance, information on, for example, the function of the cooking robot 11 and the kitchen environment (the number of stoves) so as to determine the sequence in step S202. Alternatively, the cooking process determination unit 121 stores such information in the storage unit 103, and acquires the information.

In addition, examples of the information to be used for sequence determination include the following.

(a) Whether the dish to be cooked is a main dish or garnish (a main dish is cooked last)

(b) Expected cooking time (if the expected cooking time is long, it is necessary to start cooking the dish immediately after starting a cooking process)

(c) The dish can be reheated or kept warm, or is to be served cold (in this case, the cooking of the dish is started at an early stage after the cooking process is started)

(d) Whether dishes are similar in cooking process and what cooking utensils are used (to be used for determining whether the dishes can be cooked simultaneously)

These pieces of information are acquired from the storage unit 103, the external recipe information providing server, or the like. The cooking process determination unit 121 determines the basic cooking sequence on the basis of these pieces of information.

(Step S203)

Next, the cooking process determination unit 121 determines a detailed cooking process in the basic sequence in step S203. The cooking process is determined with reference to, for example, the external recipe information providing server or information stored in the storage unit 103.

(Step S204)

Next, in order to set a break point in the cooking process determined by the cooking process determination unit 121, the break point detection unit 123 refers to the recipe information acquired by the cooking process determination unit 121 to check whether or not a break point has been recorded in the recipe information.

In a case where a break point has been recorded in the recipe information, the process proceeds to step S206.

In a case where no break point has been recorded in the recipe information, the process proceeds to step S205.

(Step S205)

In a case where no break point has been recorded in the recipe information, the break point detection unit 123 analyzes in step S205 the characteristics of the dishes to be cooked, and determines a break point for each dish on the basis of the analyzed characteristics. This process is, for example, the process described above with reference to FIG. 14.

Specifically, for example, the following process is performed.

In a case where a cooking sequence has been set in which, for example, a dish that tastes good even when cold or a dish that can be reheated is cooked first, a point at which each dish is ready is set as a break point. That is, a break point is set each time the cooking of each dish is completed.

A suspension prohibited point is detected from the recipe, and other cooking steps are treated as candidates for a break point.

The suspension prohibited point refers to, for example, the following cooking step.

A cooking step for which heating with a stove or an IH cooker is specified, such as a cooking step in which “oil is heated in a frying pan and vegetables are stir-fried”, is considered a suspension prohibited point because the ingredients will burn if cooking is suspended here.

However, heating with a microwave oven is not included. This is because heating with a microwave oven is included in a cooking step of preparation of ingredients, and the like.

In addition, a cooking step for which the time required is specified is also considered a suspension prohibited point.

For example, such a cooking step of “sprinkling salt on fish and starting to grill the fish after 10 minutes” is considered a suspension prohibited point because if cooking is suspended here, the fish may become watery, so that the taste may deteriorate.

In addition, a cooking step in which “onions are sliced and the sliced onions are soaked in water for five minutes” is considered a suspension prohibited point because if cooking is suspended here, nutrients may be washed away.

A process may be performed in which a suspension prohibited point is picked out from the recipe and other parts are set as break points.

(Step S206)

Finally, in step S206, the break point detection unit 123 stores, in the storage unit 103, at least either of the break points obtained from the recipe information or the break point for each dish determined in step S205 on the basis of the characteristics of the dishes to be cooked, together with the cooking process determined by the cooking process determination unit 121.

The process of suspension of cooking to be performed when the cooking process is performed according to the flowcharts shown in FIGS. 7 to 13 described above is performed with reference to the break point information stored in the storage unit 103 according to the above-described process, that is, the flow shown in FIG. 15.

[5. Regarding Other Embodiments]

Next, embodiments different from the above-described embodiment will be described.

The following embodiments will be described.

(1) Embodiment for a case where there is a plurality of users being out

(2) Embodiment for a case where a cooking robot cooks in collaboration with a user

(3) Embodiment for a case where the cooking robot cannot cook

(4) Embodiment of using a plurality of cooking robots

(5) Embodiment applicable to a case where a user returns home earlier than an initial setting

(1) Embodiment for a Case where there is a Plurality of Users being Out

In the above-described embodiment, there is a single user being out. Thus, cooking just needs to be completed at the expected time for the single user to return home.

However, there may be a plurality of users being out.

In such a case, the expected time to return home (X1, X2, . . . , Xn) is stored for all n users being out in a storage unit and updated as needed.

Moreover, the expected time to complete cooking (Y) is set to the expected time to return home for a user who returns home last.

For example, in a case where the cooking of dinner is to be completed by the time when a father and a mother return home from work in a situation where the expected time for the father and the mother to return home is set as follows, cooking is performed such that dinner is ready at 19:10:

the expected time for the father to return home (X1)=18:45, and

the expected time for the mother to return home (X2)=19:10. That is, the expected time to complete cooking (Y) is set as follows:

the expected time to complete cooking (Y)=19:10.

However, this setting can be changed at the user's request. For example, in a case where it is not necessary to take into consideration the expected time for the mother to return home (the cooking of dinner may be completed at 18:45), the expected time to complete cooking (Y) is set as follows:

the expected time to complete cooking (Y)=18:45=(X1).

Such setting changes can be set before going out, or can also be set from outside the home by use of the user terminal 20.

(2) Embodiment for a Case where a Cooking Robot Cooks in Collaboration with a User

In the above-described embodiment, the entire cooking process is performed by the cooking robot 11. Not limited to such a setting, the cooking robot 11 may be set in such a way as to cook in collaboration with a user.

For example, the setting is such that the user performs only the fun part of cooking.

Specifically, for example, the setting is such that the father returns home first, and cooks with the cooking robot 11 while waiting for the mother to return home.

In a case where the father is expected to return home at 18:45 and since cooking is the father's hobby, the father wants to determine how to cook a main dish in terms of seasoning, the degree of roasting, and the like by himself, the cooking robot 11 finishes preparation of ingredients by the expected time for the father to return home.

In this case, a cooking break point is set immediately before a cooking step that the father wants to perform by himself, and the cooking robot 11 stays on standby at this break point.

After that, the father returns home and then, cooks the prepared ingredients.

Furthermore, the mother is expected to return home at 19:10. Thus, the cooking robot 11 is in charge of miscellaneous tasks in cooking so that cooking is completed in time for the mother's return home.

In addition, cooking may be performed on the basis of the setting in which roles in cooking are divided according to the user's skill.

For example, a situation is set up such that a child cooks with the cooking robot 11 so as to complete cooking in time for the mother's return home.

### First Specific Example

The child and the cooking robot 11 start cooking in consideration of the expected time for the mother to return home. Here, in a case where the child is an elementary school student or the like and is still young, the cooking robot 11 is in charge of a step in which a kitchen knife is used and a step of deep-frying food. This is because these steps involve danger.

### Second Specific Example

The child cooks with the cooking robot 11 so as to complete cooking in consideration of the time when the mother will return home. Cooking is started such that cooking is completed at the expected time for the mother to return home. Here, in a case where the child is a junior high school student or the like and can use a kitchen knife, the child is in charge of a step of cutting vegetables. However, the child performs the task slowly, so that if the child keeps on performing the task, cooking cannot be completed by the expected time for the mother to return home. In such a case, the child's task is taken over by the cooking robot 11 so as to complete cooking in time for the mother's return home, and the cooking robot 11 is in charge of all the subsequent cooking steps.

(3) Embodiment for a Case where the Cooking Robot Cannot Cook

The cooking robot 11 cannot always perform all the cooking steps. In some cases, some of ingredients necessary for cooking may be unavailable. The following is an embodiment applicable to such a case.

(3a) A Case where there is a Cooking Step that Cannot be Performed by the Cooking Robot 11

The problem is whether the cooking robot 11 may perform, by itself, a step in which fire is used in a case where only the cooking robot 11 is at home.

In a case where there is a step in which fire is used in this way, the cooking robot 11 finishes a cooking process except the step in which fire is used and the subsequent steps in consideration of the time when the user will return home. That is, staying on standby at a cooking break point immediately before the step in which fire is used is an example of a solution of this problem.

Alternatively, the following measures may be taken:

the recipe is changed, or the step in which fire is used is performed by use of a microwave oven as a substitute for fire.

(3b) A Case where an Ingredient Necessary for Cooking is Unavailable

The cooking robot 11 cannot perform cooking also in a case where an ingredient necessary for cooking is unavailable.

In such a case, the cooking robot control apparatus 10 performs the following processing.

Notify a user (by use of a smartphone, or the like) that an ingredient is insufficient when a recipe is determined.

Since it is anticipated that cooking will not be completed when the user returns home, approval for this point is obtained.

The user is requested to buy the insufficient ingredient on the user's way home.

In a case where the user buys the additional ingredient on the user's way home, cooking is started in view of the time required for that.

A cooking process is finished except a step in which the insufficient ingredient is used and the subsequent steps in consideration of the time when the user will return home so that cooking can be resumed as soon as the ingredient is received.

The cooking robot 11 stays on standby at a cooking break point immediately before the step in which the insufficient ingredient is used.

(4) Embodiment of Using a Plurality of Cooking Robots

In the embodiment described above, the single cooking robot 11 is used. However, it is also possible to adopt a configuration in which a plurality of the cooking robots 11 is used to perform cooking.

In a case where the plurality of cooking robots 11 is used in this way, the plurality of cooking robots cooks one or more dishes. A break point is individually set in a sequence for cooking to be performed by each cooking robot.

Note that in a case where the robots cook the same dish in parallel, all the robots suspend and resume cooking at the same cooking break point. Even if there is a difference in the progress of work between the robots, the robots suspend cooking when the same cooking break point is reached.

For example, suppose that two cooking robots (robot A and robot B) form hamburger patties and quotas of forming patties assigned to the robot A and the robot B are 10 and 15, respectively.

Here, suppose that there arises a need to suspend cooking. The robot A suspends cooking because the robot A has finished forming 10 hamburger patties. Then, the robot B suspends cooking because the robot B has finished forming 15 hamburger patties.

After that, the robot A and the robot B resume cooking at the same timing.

Furthermore, in a case where the robots that are cooking different dishes suspend cooking, the robots suspend cooking after proceeding with the cooking processes up to respective cooking break points of the dishes.

For example, suppose that cooking is started by the robot A that is in charge of simmered root vegetables and the robot B that is in charge of deep-fried chicken and after that, there arises a need to suspend cooking.

In such a case, the nearest break point for the robot A comes after the parboiling of the root vegetables is finished, and the nearest break point for the robot B comes after cutting the chicken.

In this case, the robots A and B suspend cooking after proceeding with the cooking processes up to the respective nearest cooking break points. The timing for resuming cooking just needs to be determined on the basis of remaining cooking time for the respective dishes of which the robots are in charge.

(5) Embodiment Applicable to a Case where a User Returns Home Earlier than an Initial Setting

The embodiments described above can be applied to a case where the user returns home later than the initial setting. Meanwhile, in a case where the user returns home earlier than the initial setting, cooking is completed later than the time of the user's return home.

A configuration for solving such a problem will be described.

For example, in a case where a user habitually returns home at 19:00 almost every day, but sometimes returns home earlier than usual, that is, at around 18:30, cooking is started with the expected time to complete cooking (Y) set to 18:30 every day.

In a case where after the start of cooking with this setting, it has become clear that the user will return home at 19:00 as usual, cooking will be suspended for 30 minutes and the expected time to complete cooking (Y) will be set to 19:00.

Meanwhile, in a case where after the start of cooking, it has become clear that the user will return home at 18:30 earlier than usual, cooking is performed without being suspended. With this process, the expected time to complete cooking (Y) can be set to 18:30.

In this way, in a case where the range of the expected time to return home can be predicted, it is possible to start cooking in such a way as to complete cooking at the earliest time and adjust cooking completion time by setting suspension time thereafter.

[6. Regarding Hardware Configuration Example of Information Processing Apparatus]

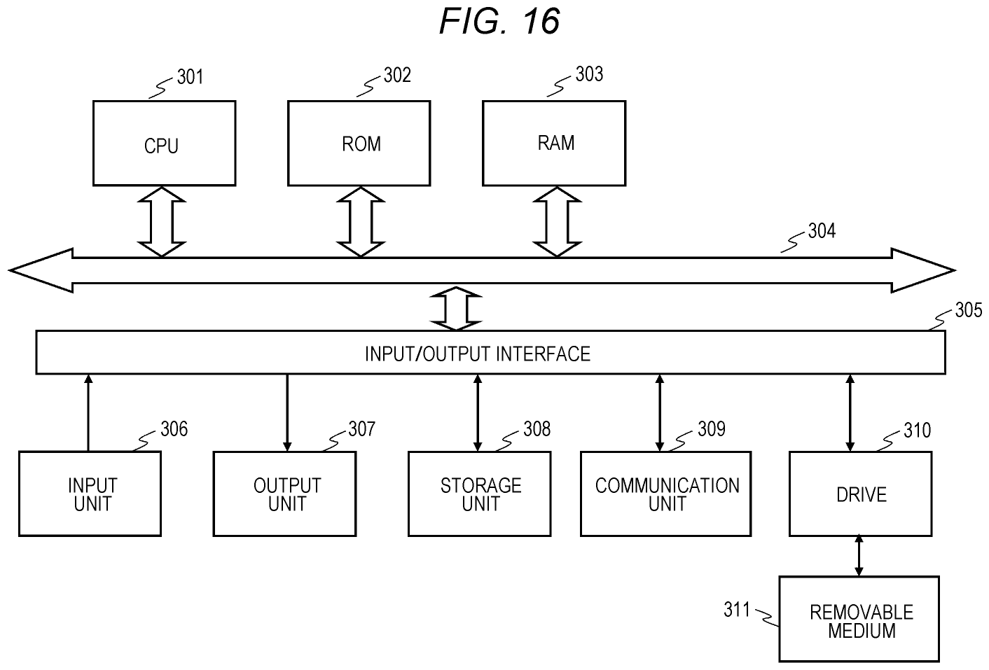

Next, a hardware configuration example of the information processing apparatus included in the cooking robot control apparatus 10 of the present disclosure will be described with reference to FIG. 16.

The hardware to be described with reference to FIG. 16 is an example of the hardware configuration of the information processing apparatus included in the cooking robot control apparatus 10 described above with reference to FIG. 6.

A central processing unit (CPU) 301 functions as a control unit or a data processing unit that performs various types of processing according to programs stored in a read only memory (ROM) 302 or a storage unit 308. For example, the CPU 301 performs processing according to the sequences described in the above-described embodiments. Programs to be performed by the CPU 301, data, and the like are stored in a random access memory (RAM) 303. The CPU 301, the ROM 302, and the RAM 303 are connected to each other by a bus 304.

The CPU 301 is connected to an input/output interface 305 via the bus 304. The input/output interface 305 is connected to an input unit 306 and an output unit 307. The input unit 306 includes various switches, a keyboard, a mouse, a microphone, a sensor, and the like. The output unit 307 includes a display, a speaker, and the like.

The input unit 306 and the output unit 307 each include a robot I/F, which is also used for outputting commands to the cooking robot 11 and inputting information from the cooking robot 11.

The CPU 301 performs various types of processing in response to commands input from the input unit 306, and outputs processing results to, for example, the output unit 307.

The storage unit 308 connected to the input/output interface 305 includes, for example, a hard disk, and stores programs to be executed by the CPU 301 and various data. A communication unit 309 functions as a transmission/reception unit for Wi-Fi communication, Bluetooth (registered trademark) (BT) communication, and other data communication via a network such as the Internet or a local area network, and communicates with an external device.

A drive 310 connected to the input/output interface 305 drives a removable medium 311 to perform the recording or reading of data. Examples of the removable medium 311 include a magnetic disk, an optical disk, a magneto-optical disk, and a semiconductor memory such as a memory card.

[7. Summary of Configurations of Present Disclosure]

The embodiments of the present disclosure have been described above in detail with reference to specific examples. However, it is obvious that those skilled in the art can make modifications and substitutions of the embodiments without departing from the gist of the present disclosure. In other words, the present invention has been disclosed in the form of exemplification, and should not be restrictively interpreted. In order to judge the gist of the present disclosure, the section “CLAIMS” should be taken into consideration.

Note that the technology disclosed in the present specification can adopt the following configurations.

(1) An information processing apparatus including:

an expected return home time estimation unit that estimates an expected time to return home at which a user is expected to return home;

an expected cooking completion time estimation unit that estimates an expected time to complete cooking at which a cooking robot is expected to complete cooking; and

a cooking execution control unit that controls the cooking robot,

in which the cooking execution control unit controls the cooking robot according to the expected time to return home (X) estimated by the expected return home time estimation unit and the expected time to complete cooking (Y) estimated by the expected cooking completion time estimation unit.

(2) The information processing apparatus according to (1), in which

the cooking execution control unit controls the cooking robot such that a difference (X−Y) between the expected time to return home (X) and the expected time to complete cooking (Y) is less than a predetermined threshold value (Th).

(3) The information processing apparatus according to (1) or (2), in which

in a case where a difference (X−Y) between the expected time to return home (X) and the expected time to complete cooking (Y) is not less than a predetermined threshold value (Th), the cooking execution control unit performs control to cause the cooking robot to suspend cooking.

(4) The information processing apparatus according to any one of (1) to (3), further including:

a break point detection unit that sets a break point at which cooking is suspended, in a cooking process to be performed by the cooking robot.

(5) The information processing apparatus according to (4), in which

the cooking execution control unit causes the cooking robot to suspend cooking at the break point set by the break point detection unit.

(6) The information processing apparatus according to (4) or (5), in which

the break point detection unit detects the break point on the basis of a recipe of a dish to be cooked by the cooking robot.

(7) The information processing apparatus according to any one of (4) to (6) in which

the break point detection unit detects a suspension prohibited point at which suspension is not allowed, on the basis of a recipe of a dish to be cooked by the cooking robot, and sets a break point at a position other than the detected suspension prohibited point.

(8) The information processing apparatus according to any one of (1) to (7), in which

the expected return home time estimation unit receives location information from a user terminal held by the user, and performs a process of estimating and sequentially updating the expected time to return home (X).

(9) The information processing apparatus according to any one of (1) to (8), in which

the expected return home time estimation unit receives traffic information from an external server, and performs a process of estimating and sequentially updating the expected time to return home (X).

(10) The information processing apparatus according to any one of (1) to (9), in which

the cooking execution control unit calculates a difference (X−Y) by using a latest expected time to return home (X) updated by the expected return home time estimation unit and the expected time to complete cooking (Y), and controls the cooking robot such that the difference (X−Y) is less than a predetermined threshold value (Th).

(11) The information processing apparatus according to any one of (1) to (10), in which

in a case where cooking being performed by the cooking robot is suspended, the expected cooking completion time estimation unit performs a process of updating the expected time to complete cooking (Y) by adding a suspension time to the expected time to complete cooking (Y).

(12) The information processing apparatus according to any one of (1) to (11), in which

the cooking execution control unit calculates a difference (X−Y) by using the expected time to return home (X) and a latest expected time to complete cooking (Y) updated by the expected cooking completion time estimation unit, and controls the cooking robot such that the difference (X−Y) is less than a predetermined threshold value (Th).

(13) An information processing system including:

a user terminal; and

a cooking robot control apparatus that controls a cooking robot,

in which the user terminal transmits location information to the cooking robot control apparatus,

the cooking robot control apparatus includes:

an expected return home time estimation unit that estimates an expected time to return home at which a user is expected to return home, on the basis of the location information received from the user terminal;

an expected cooking completion time estimation unit that estimates an expected time to complete cooking at which the cooking robot is expected to complete cooking; and

a cooking execution control unit that controls the cooking robot, and

the cooking execution control unit controls the cooking robot according to the expected time to return home (X) estimated by the expected return home time estimation unit and the expected time to complete cooking (Y) estimated by the expected cooking completion time estimation unit.

(14) The information processing system according to (13), in which

the cooking robot control apparatus includes a break point detection unit that sets a break point at which cooking is suspended, in a cooking process to be performed by the cooking robot, and

the cooking execution control unit causes the cooking robot to suspend cooking at the break point set by the break point detection unit.

(15) An information processing method to be performed in an information processing apparatus, the method including:

an expected return home time estimation step of causing an expected return home time estimation unit to estimate an expected time to return home (X) at which a user is expected to return home;

an expected cooking completion time estimation step of causing an expected cooking completion time estimation unit to estimate an expected time to complete cooking (Y) at which a cooking robot is expected to complete cooking; and

a cooking execution control step of causing a cooking execution control unit to control the cooking robot,

in which the cooking execution control step includes controlling the cooking robot according to the expected time to return home (X) and the expected time to complete cooking (Y).

(16) An information processing method to be performed in an information processing system including a user terminal and a cooking robot control apparatus that controls a cooking robot, the method including:

causing the user terminal to transmit location information to the cooking robot control apparatus; and

causing the cooking robot control apparatus to perform:

an expected return home time estimation process of estimating an expected time to return home (X) at which a user is expected to return home, on the basis of the location information received from the user terminal;

an expected cooking completion time estimation process of estimating an expected time to complete cooking at which the cooking robot is expected to complete cooking; and

a cooking execution control process of controlling the cooking robot,

in which the cooking execution control process includes controlling the cooking robot according to the expected time to return home (X) and the expected time to complete cooking (Y).

(17) A program for causing an information processing apparatus to perform information processing, the program causing the information processing apparatus to perform:

an expected return home time estimation step of causing an expected return home time estimation unit to estimate an expected time to return home (X) at which a user is expected to return home;

an expected cooking completion time estimation step of causing an expected cooking completion time estimation unit to estimate an expected time to complete cooking (Y) at which a cooking robot is expected to complete cooking; and

a cooking execution control step of causing a cooking execution control unit to control the cooking robot,

in which the cooking execution control step includes controlling the cooking robot according to the expected time to return home (X) and the expected time to complete cooking (Y).

Furthermore, the series of processes described in the specification can be implemented by hardware, software, or a configuration in which hardware and software are combined. In a case where the processes are implemented by software, it is possible to execute a program in which a process sequence has been recorded, after installing the program in a memory in a computer incorporated in dedicated hardware or installing the program on a general-purpose computer capable of performing various types of processing. For example, the program can be recorded in advance on a recording medium. In addition to being installed on a computer from the recording medium, the program can be received via a network such as a local area network (LAN) or the Internet and installed on a recording medium such as a built-in hard disk.

Note that the various processes described in the specification may be performed not only in time series according to the description, but also in parallel or separately depending on the processing capacity of an apparatus that performs the processes or depending on the needs. Furthermore, in the present specification, the term “system” refers to a logical set configuration of a plurality of devices, and is not limited to one in which the devices of each configuration are in the same casing.

### INDUSTRIAL APPLICABILITY

As described above, the configuration of one embodiment of the present disclosure achieves a configuration in which suspension of cooking being performed by a cooking robot is controlled to enable cooking to be completed at the expected time for a user to return home.

Specifically, included are, for example, an expected return home time estimation unit that estimates an expected time to return home at which a user is expected to return home; an expected cooking completion time estimation unit that estimates an expected time to complete cooking at which a cooking robot is expected to complete cooking; and a cooking execution control unit that controls the cooking robot. In a case where a difference (X−Y) between the expected time to return home (X) estimated by the expected return home time estimation unit and the expected time to complete cooking (Y) estimated by the expected cooking completion time estimation unit is not less than a predetermined threshold value (Th), the cooking execution control unit performs control to cause the cooking robot to suspend cooking so that cooking can be completed at the expected time to return home (X).

The present configuration achieves a configuration in which suspension of cooking being performed by the cooking robot is controlled to enable cooking to be completed at the expected time for the user to return home.

### REFERENCE SIGNS LIST

10 Cooking robot control apparatus
11 Cooking robot
20 User terminal
101 Communication unit
102 Data processing unit
103 Storage unit
104 Robot I/F
111 Expected return home time estimation unit
112 Cooking process planning unit
113 Cooking execution control unit
121 Cooking process determination unit
122 Expected cooking completion time estimation unit
123 Break point detection unit
301 CPU
302 ROM
303 RAM
304 Bus
305 Input/output interface
306 Input unit
307 Output unit
308 Storage unit
309 Communication unit
310 Drive
311 Removable medium

1. An information processing apparatus comprising:
an expected return home time estimation unit that estimates an expected time to return home at which a user is expected to return home;
an expected cooking completion time estimation unit that estimates an expected time to complete cooking at which a cooking robot is expected to complete cooking; and
a cooking execution control unit that controls the cooking robot,
wherein the cooking execution control unit controls the cooking robot according to the expected time to return home (X) estimated by the expected return home time estimation unit and the expected time to complete cooking (Y) estimated by the expected cooking completion time estimation unit.

2. The information processing apparatus according to claim 1, wherein
the cooking execution control unit controls the cooking robot such that a difference (X−Y) between the expected time to return home (X) and the expected time to complete cooking (Y) is less than a predetermined threshold value (Th).

3. The information processing apparatus according to claim 1, wherein
in a case where a difference (X−Y) between the expected time to return home (X) and the expected time to complete cooking (Y) is not less than a predetermined threshold value (Th), the cooking execution control unit performs control to cause the cooking robot to suspend cooking.

4. The information processing apparatus according to claim 1, further comprising:
a break point detection unit that sets a break point at which cooking is suspended, in a cooking process to be performed by the cooking robot.

5. The information processing apparatus according to claim 4, wherein
the cooking execution control unit causes the cooking robot to suspend cooking at the break point set by the break point detection unit.

6. The information processing apparatus according to claim 4, wherein
the break point detection unit detects the break point on a basis of a recipe of a dish to be cooked by the cooking robot.

7. The information processing apparatus according to claim 4, wherein
the break point detection unit detects a suspension prohibited point at which suspension is not allowed, on a basis of a recipe of a dish to be cooked by the cooking robot, and sets a break point at a position other than the detected suspension prohibited point.

8. The information processing apparatus according to claim 1, wherein
the expected return home time estimation unit receives location information from a user terminal held by the user, and performs a process of estimating and sequentially updating the expected time to return home (X).

9. The information processing apparatus according to claim 1, wherein
the expected return home time estimation unit receives traffic information from an external server, and performs a process of estimating and sequentially updating the expected time to return home (X).

10. The information processing apparatus according to claim 1, wherein
the cooking execution control unit calculates a difference (X−Y) by using a latest expected time to return home (X) updated by the expected return home time estimation unit and the expected time to complete cooking (Y), and controls the cooking robot such that the difference (X−Y) is less than a predetermined threshold value (Th).

11. The information processing apparatus according to claim 1, wherein
in a case where cooking being performed by the cooking robot is suspended, the expected cooking completion time estimation unit performs a process of updating the expected time to complete cooking (Y) by adding a suspension time to the expected time to complete cooking (Y).

12. The information processing apparatus according to claim 1, wherein
the cooking execution control unit calculates a difference (X−Y) by using the expected time to return home (X) and a latest expected time to complete cooking (Y) updated by the expected cooking completion time estimation unit, and controls the cooking robot such that the difference (X−Y) is less than a predetermined threshold value (Th).

13. An information processing system comprising:
a user terminal; and
a cooking robot control apparatus that controls a cooking robot,
wherein the user terminal transmits location information to the cooking robot control apparatus,
the cooking robot control apparatus includes:
an expected return home time estimation unit that estimates an expected time to return home at which a user is expected to return home, on a basis of the location information received from the user terminal;
an expected cooking completion time estimation unit that estimates an expected time to complete cooking at which the cooking robot is expected to complete cooking; and
a cooking execution control unit that controls the cooking robot, and
the cooking execution control unit controls the cooking robot according to the expected time to return home (X) estimated by the expected return home time estimation unit and the expected time to complete cooking (Y) estimated by the expected cooking completion time estimation unit.

14. The information processing system according to claim 13, wherein
the cooking robot control apparatus includes a break point detection unit that sets a break point at which cooking is suspended, in a cooking process to be performed by the cooking robot, and
the cooking execution control unit causes the cooking robot to suspend cooking at the break point set by the break point detection unit.

15. An information processing method to be performed in an information processing apparatus, the method comprising:
an expected return home time estimation step of causing an expected return home time estimation unit to estimate an expected time to return home (X) at which a user is expected to return home;
an expected cooking completion time estimation step of causing an expected cooking completion time estimation unit to estimate an expected time to complete cooking (Y) at which a cooking robot is expected to complete cooking; and
a cooking execution control step of causing a cooking execution control unit to control the cooking robot,
wherein the cooking execution control step includes controlling the cooking robot according to the expected time to return home (X) and the expected time to complete cooking (Y).

16. An information processing method to be performed in an information processing system including a user terminal and a cooking robot control apparatus that controls a cooking robot, the method comprising:
causing the user terminal to transmit location information to the cooking robot control apparatus; and
causing the cooking robot control apparatus to perform:
an expected return home time estimation process of estimating an expected time to return home (X) at which a user is expected to return home, on a basis of the location information received from the user terminal;
an expected cooking completion time estimation process of estimating an expected time to complete cooking at which the cooking robot is expected to complete cooking; and
a cooking execution control process of controlling the cooking robot,
wherein the cooking execution control process includes controlling the cooking robot according to the expected time to return home (X) and the expected time to complete cooking (Y).

17. A program for causing an information processing apparatus to perform information processing, the program causing the information processing apparatus to perform:
an expected return home time estimation step of causing an expected return home time estimation unit to estimate an expected time to return home (X) at which a user is expected to return home;
an expected cooking completion time estimation step of causing an expected cooking completion time estimation unit to estimate an expected time to complete cooking (Y) at which a cooking robot is expected to complete cooking; and
a cooking execution control step of causing a cooking execution control unit to control the cooking robot,
wherein the cooking execution control step includes controlling the cooking robot according to the expected time to return home (X) and the expected time to complete cooking (Y).
